(19) United States
(12) Patent Application Publication
(10) Pub. No.: US 2026/0186263 A1
(43) Pub. Date: Jul. 2, 2026

(54) OPTICAL IMAGING SYSTEM

(71) Applicant: Samsung Electro-Mechanics Co., Ltd., Suwon-si (KR)

(72) Inventors: Dong Hyuk JANG, Suwon-si (KR); Sang Hyun JANG, Suwon-si (KR)

(73) Assignee: Samsung Electro-Mechanics Co., Ltd., Suwon-si (KR)

(21) Appl. No.: 19/368,732

(22) Filed: Oct. 24, 2025

(30) Foreign Application Priority Data
Dec. 31, 2024 (KR) 10-2024-0201625

(51) Int. Cl. G02B 13/00; G02B 9/64

(52) U.S. Cl. CPC G02B 13/0045; G02B 9/64

(57) ABSTRACT

An optical imaging system includes a first lens having positive refractive power; a second lens having negative refractive power; a third lens having refractive power; a fourth lens having refractive power; a fifth lens having negative refractive power; a sixth lens having positive refractive power; a seventh lens having refractive power; and an eighth lens having negative refractive power. The first to eighth lenses are disposed in order from an object side, wherein 0.8<FNO×(OAL/IMH)≤1.0 is satisfied, where FNO is a value (F-number) representing a brightness of the optical imaging system, OAL is a distance on an optical axis from an object-side surface of the first lens to an imaging plane, and IMH is a diagonal length of the imaging plane.

### CROSS-REFERENCE TO RELATED APPLICATIONS

This application claims the benefit under 35 USC 119(a) of Korean Patent Application No. 10-2024-0201625 filed on Dec. 31, 2024, in the Korean Intellectual Property Office, the entire disclosure of which is incorporated herein by reference for all purposes.

### BACKGROUND

### 1. Field

The present disclosure relates to an optical imaging system including eight lenses.

### 2. Description of the Background

A camera of a mobile device may include an image sensor having between 13 to 200 million pixels. The design of the lens of the mobile device may be optimized to correspond to such a high-resolution image sensor.

As the size of an image sensor generally increases, the overall length of the optical system may also increase. However, as mobile devices are manufactured to have a slim thickness, it may be desirable to develop an optical system that provides high performance while maintaining a reduced thickness.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having positive refractive power; a second lens having negative refractive power; a third lens having refractive power; a fourth lens having refractive power; a fifth lens having negative refractive power; a sixth lens having positive refractive power; a seventh lens having refractive power; and an eighth lens having negative refractive power. The first to eighth lenses are disposed in order from an object side, wherein 0.8<FNO×(OAL/IMH)≤1.0 is satisfied, where FNO is a value (F-number) representing a brightness of the optical imaging system, OAL is a distance on an optical axis from an object-side surface of the first lens to an imaging plane, and IMH is a diagonal length of the imaging plane.

The third lens may have positive refractive power, and an image-side surface may be concave.

The fourth lens may have negative refractive power.

The fourth lens may have a convex object-side surface and a concave image-side surface.

The seventh lens may have positive refractive power, and wherein 2<f7/f<5 is satisfied, where f7 is a focal length of the seventh lens, and f is a total focal length of the optical imaging system.

The eighth lens may have a convex object-side surface.

The optical imaging system wherein 0<f1/f<1 may be satisfied, where f1 is a focal length of the first lens, and f is a total focal length of the optical imaging system.

The optical imaging system wherein 150°<FOV×IMH/f<180° may be satisfied, where FOV is a field of view of the optical imaging system, and f is a total focal length of the optical imaging system.

The optical imaging system wherein 1.0<OAL/f<1.2 may be satisfied, where f is a total focal length of the optical imaging system.

The optical imaging system wherein 10<V1−(V6+V7)/2<30 may be satisfied, where V1 is an Abbe number of the first lens, V6 is an Abbe number of the sixth lens, and V7 is an Abbe number of the seventh lens.

In another general aspect, an optical imaging system includes a first lens, a second lens, a third lens, a fourth lens, a fifth lens, a sixth lens, a seventh lens, and an eighth lens disposed in order with a predetermined distance therebetween from an object side. An Abbe number of each of the second lens and the fourth lens is less than 20, wherein 150°<FOV×IMH/f<180° is satisfied, where FOV is a field of view of the optical imaging system, and f is a total focal length of the optical imaging system.

The optical imaging system may further include a stop disposed between the third lens and the fourth lens.

The optical imaging system wherein each of three lenses among the first to eighth lenses may have a refractive index of 1.6 or greater.

The optical imaging system wherein-3<f2/f<−1 and −20<f5/f<−5 may be satisfied, where f2 is a focal length of the second lens, and f5 is a focal length of the fifth lens.

The optical imaging system wherein 1<f6/f<6 and −1<f8/f<0 may be satisfied, where f6 is a focal length of the sixth lens, and f8 is a focal length of the eighth lens.

The optical imaging system wherein 30<V1-V4<45 may be satisfied, where V1 is an Abbe number of the first lens, and V4 is an Abbe number of the fourth lens.

Other features and aspects will be apparent from the following detailed description, the drawings, and the claims.

### BRIEF DESCRIPTION OF DRAWINGS

FIG. 1A is a configuration diagram illustrating an optical imaging system according to a first embodiment of the present disclosure.

FIG. 1B is a graph showing aberration characteristics of an optical imaging system according to the first embodiment of the present disclosure.

FIG. 2A is a configuration diagram illustrating an optical imaging system according to a second embodiment of the present disclosure.

FIG. 2B is a graph showing aberration characteristics of an optical imaging system according to the second embodiment of the present disclosure.

FIG. 3A is a configuration diagram illustrating an optical imaging system according to a third embodiment of the present disclosure.

FIG. 3B is a graph showing aberration characteristics of an optical imaging system according to the third embodiment of the present disclosure.

FIG. 4A is a configuration diagram illustrating an optical imaging system according to a fourth embodiment of the present disclosure.

FIG. 4B is a graph showing aberration characteristics of an optical imaging system according to the fourth embodiment of the present disclosure.

FIG. 5A is a configuration diagram illustrating an optical imaging system according to a fifth embodiment of the present disclosure.

FIG. 5B is a graph showing aberration characteristics of an optical imaging system according to the fifth embodiment of the present disclosure.

FIG. 6A is a configuration diagram illustrating an optical imaging system according to a sixth embodiment of the present disclosure.

FIG. 6B is a graph showing aberration characteristics of an optical imaging system according to the sixth embodiment of the present disclosure.

FIG. 7A is a configuration diagram illustrating an optical imaging system according to a seventh embodiment of the present disclosure.

FIG. 7B is a graph showing aberration characteristics of an optical imaging system according to the seventh embodiment of the present disclosure.

FIG. 8A is a configuration diagram illustrating an optical imaging system according to an eighth embodiment of the present disclosure.

FIG. 8B is a graph showing aberration characteristics of an optical imaging system according to the eighth embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In the embodiments, a first lens may indicate the lens closest to an object side, and an eighth lens may indicate the lens closest to an imaging plane (or image sensor).

Also, in the embodiments, a unit of a radius of curvature, thickness, distance, and focal length of a lens may be mm, and a unit of field of view may be degrees (°).

In the description related to the shape of a lens of the embodiments, a convex surface may indicate that a paraxial region (a narrow region in the vicinity of an optical axis) portion of a surface may be convex, and a concave surface may indicate that a paraxial region portion of the surface may be concave. Accordingly, even when one surface of the lens is described as having a convex shape, an edge portion of the lens may be concave. Similarly, even when one surface of a lens is described as having a concave shape, an edge portion of the lens may be convex.

The optical imaging system according to the embodiments may include eight lenses. For example, the optical imaging system may include, in order from the object side, a first lens, a second lens, a third lens, a fourth lens, a fifth lens, a sixth lens, a seventh lens, and an eighth lens disposed in order from an object side.

However, the optical imaging system according to embodiments may not include only eight lenses, and may further include other components if desired.

The optical imaging system according to embodiments may further include an image sensor configured to convert incident light from a subject into an electrical signal.

Also, for example, the optical imaging system may further include an infrared blocking filter (hereinafter, “filter”) configured to block infrared light incident to the image sensor.

Also, for example, the optical imaging system may further include a stop configured to adjust the amount of light. For example, a stop may be disposed in at least one of the regions, that is, on an object side of the first lens, between an object-side surface of the first lens and an image-side surface of the first lens, and between the third lens and the fourth lens.

The optical imaging system according to embodiments may include a lens formed of a plastic material. For example, the entirety of the first to eighth lenses may be formed of a plastic material.

According to embodiments, at least one of the first to eighth lenses may have a shape having an inflection point. For example, at least one of the first to eighth lenses may include an inflection point on at least one of an object-side surface and an image-side surface.

Also, at least one of the first to eighth lenses may have an aspherical surface. For example, object-side surfaces and image-side surfaces of the first to eighth lenses may be aspherical. The aspherical surfaces of the first to eighth lenses may be represented by equation 1 as below.

$$\begin{matrix}Z = \frac{{cY}^{2}}{1 + \sqrt{1 - ( 1 + K )} {c}^{2} {Y}^{2}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + & Equation 1\end{matrix} {MY}^{24} + {NY}^{26} + {OY}^{28} + {PY}^{30} …$$

In Equation 1, c is the curvature of a lens (the inverse of the radius of curvature), K is the conic constant, and Y is the distance from an arbitrary point on an aspherical surface of the lens to the optical axis. Also, constants A to H, J, and L to P are aspheric coefficients, and Z(SAG) is the distance in the optical axis direction between an arbitrary point on the aspherical surface of the lens and an apex of the aspherical surface.

The optical imaging system according to embodiments may have a field of view (FOV) range of a wide-angle lens. For example, the optical imaging system according to embodiments may have a field of view greater than 60° and less than 90°. Also, preferably, a field of view may be greater than 80° and less than 90°.

The optical imaging system according to embodiments may satisfy one or more of the conditional expressions as below.

$$150 ° < FOV \times IMH / f < 180 ° \qquad Conditional Expression 1$$

$$1.5 < FNO \leq 1.8 \qquad Conditional Expression 2$$

$$0.5 < OAL / IMH < 0.6 \qquad Conditional Expression 3$$

$$0.8 < FNO \times OAL / IMH ) \leq 1. \qquad Conditional Expression 4$$

$$25 < V 1 - V 2 < 45 \qquad Conditional Expression 5$$

$$30 < V 1 - V 4 < 45 \qquad Conditional Expression 6$$

$$10 < V 1 - ( V 6 + V 7 ) / 2 < 30 \qquad Conditional Expression 7$$

$$0 < f 1 / f < 1 \qquad Conditional Expression 8$$

$$- 3 < f 2 / f < - 1 \qquad Conditional Expression 9$$

$$1 < \vert f 3 / f \vert < 5 \qquad Conditional Expression 10$$

$$1 < \vert f 4 / f \vert / 10 < 10 \qquad Conditional Expression 11$$

$$- 20 < f 5 / f < - 5 \qquad Conditional Expression 12$$

$$1 < f 6 / f < 6 \qquad Conditional Expression 13$$

$$2 < f 7 / f < 5 \qquad Conditional Expression 14$$

$$- 1 < f 8 / f < 0 \qquad Conditional Expression 15$$

$$- 0.6 < f 1 / f 2 < 0 \qquad Conditional Expression 16$$

$$0 < f 1 / f 3 < 1 \qquad Conditional Expression 17$$

$$1. < OA L / f < 1.2 \qquad Conditional Expression 18$$

$$0.1 < BF L / f < 0.3 \qquad Conditional Expression 19$$

$$0 < D 1 / f < 0.1 \qquad Conditional Expression 20$$

In the conditional expressions, FOV is the field of view of the optical imaging system, FNO is the value representing the brightness of the optical imaging system (F-number), IMH is the diagonal length of an imaging plane of the image sensor, OAL is the distance on the optical axis from an object-side surface of the first lens to the imaging plane, BFL is the distance on the optical axis from an image-side surface of the eighth lens to the imaging plane, and D1 is the air gap (or the distance on the optical axis from an image-side surface of the first lens to an object-side surface of the second lens) between the first lens and the second lens.

Also, in the conditional expressions, f is the total focal length of the optical imaging system, f1 is the focal length of the first lens, f2 is the focal length of the second lens, f3 is the focal length of the third lens, f4 is the focal length of the fourth lens, f5 is the focal length of the fifth lens, f6 is the focal length of the sixth lens, f7 is the focal length of the seventh lens, and f8 is the focal length of the eighth lens.

Also, in the conditional expressions, V1 is the Abbe number of the first lens, V2 is the Abbe number of the second lens, V4 is the Abbe number of the fourth lens, V6 is the Abbe number of the sixth lens, and V7 is the Abbe number of the seventh lens.

Conditional Expression 1 may be related to the field of view and miniaturization of the optical imaging system. When Conditional Expression 1 is satisfied, the optical imaging system may have an appropriate field of view, may reduce distortion aberration, and may be miniaturized. Conditional Expression 2 may be related to the brightness of the optical imaging system. Conditional Expression 3 may be a slim factor related to the miniaturization of the optical imaging system. Conditional Expression 4 may be related to the brightness and miniaturization of the optical imaging system. When Conditional Expression 4 is satisfied, the optical imaging system may be miniaturized while having appropriate brightness.

Conditional Expression 5 to Conditional Expression 7 may be related to the lens material included in the optical imaging system. When Conditional Expression 5 to Conditional Expression 7 are satisfied, the chromatic aberration of the optical imaging system may be improved.

Conditional Expression 8 to Conditional Expression 15 are ratios of the focal length of the individual lens to the total focal length of the optical imaging system. Conditional Expression 16 and Conditional Expression 17 are ratios of the focal length of the second lens or the third lens to the focal length of the first lens of the optical imaging system. When Conditional Expression 8 to Conditional Expression 17 are satisfied, the optical imaging system may effectively correct aberration.

Conditional Expression 18 and Conditional Expression 19 may be related to miniaturization of the optical imaging system, and Conditional Expression 20 may be related to a design condition for reducing chromatic aberration of the optical imaging system.

Hereinafter, an optical imaging system according to the embodiments will be described.

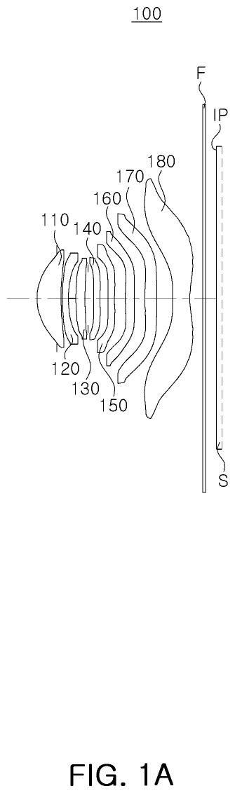

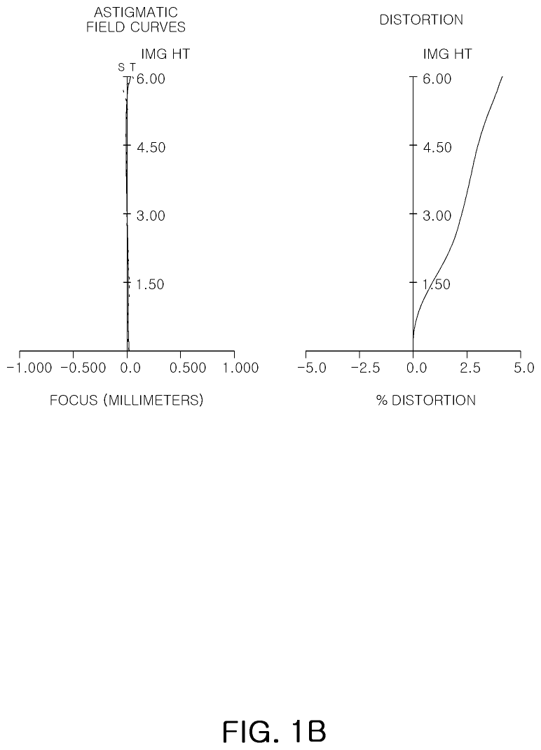

FIG. 1A is a configuration diagram illustrating an optical imaging system according to a first embodiment. FIG. 1B is a graph showing aberration characteristics of the optical imaging system according to the first embodiment.

The optical imaging system 100 according to the first embodiment may include, in order from the object side, a first lens 110, a second lens 120, a third lens 130, a fourth lens 140, a fifth lens 150, a sixth lens 160, a seventh lens 170, and an eighth lens 180.

The first lens 110 may have positive refractive power. An object-side surface of the first lens 110 may be convex in a paraxial region, and an image-side surface of the first lens 110 may be concave in a paraxial region.

The second lens 120 may have negative refractive power. An object-side surface of the second lens 120 may be convex in a paraxial region, and an image-side surface of the second lens 120 may be concave in a paraxial region. The second lens 120 may be a high-index lens having a refractive index of 1.6 or greater.

The third lens 130 may have positive refractive power. An object-side surface of the third lens 130 may be convex in a paraxial region, and an image-side surface of the third lens 130 may be concave in a paraxial region.

The fourth lens 140 may have negative refractive power. An object-side surface of the fourth lens 140 may be convex in a paraxial region, and an image-side surface of the fourth lens 140 may be concave in a paraxial region. The fourth lens 140 may be a high-index lens having a refractive index of 1.6 or greater.

The fifth lens 150 may have negative refractive power. An object-side surface of the fifth lens 150 may be convex in a paraxial region, and an image-side surface of the fifth lens 150 may be concave in a paraxial region. The fifth lens 150 may be a high-index lens having a refractive index of 1.6 or greater.

The sixth lens 160 may have positive refractive power. An object-side surface of the sixth lens 160 may be convex in a paraxial region, and an image-side surface of the sixth lens 160 may be concave in a paraxial region.

The seventh lens 170 may have positive refractive power. An object-side surface of the seventh lens 170 may be convex in a paraxial region, and an image-side surface of the seventh lens 170 may be concave in a paraxial region.

The eighth lens 180 may have negative refractive power. An object-side surface of the eighth lens 180 may be convex in a paraxial region, and an image-side surface of the eighth lens 180 may be concave in a paraxial region.

According to the first embodiment, the Abbe number of each of the first lens 110, the third lens 130, and the eighth lens 180 may be 50 or greater. The Abbe number of each of the second lens 120 and the fourth lens 140 may be less than 20. The Abbe number of each of the fifth lens 150, the sixth lens 160 and the seventh lens 170 may be 20 or greater and 40 or less.

According to the first embodiment, the first lens 110 to the eighth lens 180 may be formed of a plastic material. Also, object-side surfaces and image-side surfaces of the first lens 110 to the eighth lens 180 may be aspherical.

Table 1 lists characteristics of individual lenses included in the optical imaging system 100 according to the first embodiment, and Table 2 lists aspheric coefficients of individual lenses included in the optical imaging system 100 according to the first embodiment.

TABLE 1

| Sur- | | Radius | Thick- | Refrac- | Abbe | |
|---|---|---|---|---|---|---|
| face | | of | ness/ | tive | num- | Focal |
| No. | Notes | curvature | distance | index | ber | length |
| Object | | Infinity | Infinity | | | |
| 1 | | Infinity | −0.755 | | | |
| 2 | First lens | 2.237 | 0.910 | 1.544 | 55.99 | 4.967 |
| 3 | | 10.889 | 0.050 | | | |
| 4 | Second | 9.403 | 0.230 | 1.671 | 19.40 | −11.669 |
| | lens | | | | | |
| 5 | | 4.257 | 0.284 | | | |
| 6 | Third lens | 7.530 | 0.351 | 1.544 | 55.99 | 29.396 |
| 7 | | 13.945 | 0.114 | | | |
| 8 | Stop | Infinity | 0.206 | | | |
| 9 | Fourth | 34.908 | 0.250 | 1.671 | 19.40 | −413.584 |
| | lens | | | | | |
| 10 | | 30.958 | 0.297 | | | |
| 11 | Fifth lens | 11.729 | 0.250 | 1.614 | 25.90 | −37.113 |
| 12 | | 7.705 | 0.409 | | | |
| 13 | Sixth lens | 9.136 | 0.350 | 1.587 | 28.40 | 32.768 |
| 14 | | 17.015 | 0.394 | | | |
| 15 | Seventh | 6.945 | 0.450 | 1.567 | 37.40 | 15.384 |
| | lens | | | | | |
| 16 | | 32.440 | 0.612 | | | |
| 17 | Eighth lens | 49.628 | 0.640 | 1.535 | 55.74 | −5.182 |
| 18 | | 2.623 | 0.500 | | | |
| 19 | Filter | Infinity | 0.110 | 1.517 | 64.20 | |
| 20 | | Infinity | 0.416 | | | |
| Image | | Infinity | | | | |

TABLE 2

| Notes | 2 | 3 | 4 | 5 | 6 | 7 | 9 | 10 |
|---|---|---|---|---|---|---|---|---|
| Conic | −0.699 | −25.967 | 28.454 | 3.508 | 16.109 | −51.357 | −99.000 | −15.614 |
| constant | | | | | | | | |
| (K) | | | | | | | | |
| 4th order | 6.157E−03 | −5.488E−03 | −1.187E−02 | −1.372E−02 | −1.396E−02 | −6.729E−03 | −2.310E−02 | −2.527E−02 |
| coefficient | | | | | | | | |
| (A) | | | | | | | | |
| 6th order | 5.741E−03 | 4.981E−02 | 2.631E−02 | 5.620E−02 | −4.629E−03 | −3.995E−02 | −6.879E−02 | −6.057E−02 |
| coefficient | | | | | | | | |
| (B) | | | | | | | | |
| 8th order | −2.462E−02 | −2.087E−01 | −6.257E−02 | −2.964E−01 | 1.724E−02 | 2.781E−01 | 6.069E−01 | 5.272E−01 |
| coefficient | | | | | | | | |
| (C) | | | | | | | | |
| 10th | 7.530E−02 | 5.563E−01 | 7.943E−02 | 1.109E+00 | −1.109E−01 | −1.304E+00 | −3.261E+00 | −2.399E+00 |
| order | | | | | | | | |
| coefficient | | | | | | | | |
| (D) | | | | | | | | |
| 12th | −1.512E−01 | −9.913E−01 | 5.715E−02 | −2.841E+00 | 5.671E−01 | 4.085E+00 | 1.105E+01 | 6.767E+00 |
| order | | | | | | | | |
| coefficient | | | | | | | | |
| (E) | | | | | | | | |
| 14th | 2.086E−01 | 1.230E+00 | −3.947E−01 | 5.165E+00 | −1.732E+00 | −8.861E+00 | −2.548E+01 | −1.294E+01 |
| order | | | | | | | | |
| coefficient | | | | | | | | |
| (F) | | | | | | | | |
| 16th | −2.040E−01 | −1.090E+00 | 7.234E−01 | −6.802E+00 | 3.394E+00 | 1.374E+01 | 4.151E+01 | 1.743E+01 |
| order | | | | | | | | |
| coefficient | | | | | | | | |
| (G) | | | | | | | | |
| 18th | 1.434E−01 | 6.994E−01 | −7.717E−01 | 6.549E+00 | −4.466E+00 | −1.549E+01 | −4.855E+01 | −1.684E+01 |
| order | | | | | | | | |
| coefficient | | | | | | | | |
| (H) | | | | | | | | |
| 20th | −7.264E−02 | −3.254E−01 | 5.406E−01 | −4.603E+00 | 4.046E+00 | 1.273E+01 | 4.091E+01 | 1.171E+01 |
| order | | | | | | | | |
| coefficient | | | | | | | | |
| (J) | | | | | | | | |
| 22nd | 2.624E−02 | 1.086E−01 | −2.568E−01 | 2.331E+00 | −2.533E+00 | −7.561E+00 | −2.461E+01 | −5.820E+00 |
| order | | | | | | | | |
| coefficient | | | | | | | | |
| (L) | | | | | | | | |
| 24th | −6.586E−03 | −2.533E−02 | 8.222E−02 | −8.258E−01 | 1.078E+00 | 3.159E+00 | 1.030E+01 | 2.013E+00 |
| order | | | | | | | | |
| coefficient | | | | | | | | |
| (M) | | | | | | | | |
| 26th | 1.089E−03 | 3.913E−03 | −1.702E−02 | 1.940E−01 | −2.979E−01 | −8.803E−01 | −2.851E+00 | −4.606E−01 |
| order | | | | | | | | |
| coefficient | | | | | | | | |
| (N) | | | | | | | | |
| 28th | −1.067E−04 | −3.597E−04 | 2.060E−03 | −2.707E−02 | 4.827E−02 | 1.468E−01 | 4.687E−01 | 6.263E−02 |
| order | | | | | | | | |
| coefficient | | | | | | | | |
| (O) | | | | | | | | |
| 30th | 4.679E−06 | 1.487E−05 | −1.108E−04 | 1.696E−03 | −3.480E−03 | −1.108E−02 | −3.464E−02 | −3.830E−03 |
| order | | | | | | | | |
| coefficient | | | | | | | | |
| (P) | | | | | | | | |
| Notes | 11 | 12 | 13 | 14 | 15 | 16 | 17 | 18 |
| Conic | −97.590 | −99.000 | −10.906 | 31.008 | −4.210 | 74.288 | 40.249 | −13.013 |
| constant | | | | | | | | |
| (K) | | | | | | | | |
| 4th order | −7.216E−02 | −6.016E−02 | −3.275E−02 | −5.694E−02 | −6.382E−02 | −5.684E−02 | −1.542E−01 | −6.640E−02 |
| coefficient | | | | | | | | |
| (A) | | | | | | | | |
| 6th order | −1.105E−02 | −9.881E−03 | −4.086E−02 | 3.697E−02 | 2.366E−02 | 3.728E−02 | 9.053E−02 | 3.335E−02 |
| coefficient | | | | | | | | |
| (B) | | | | | | | | |
| 8th order | 2.402E−01 | 1.322E−01 | 1.500E−01 | −4.3625E−02 | 2.554E−02 | 4.284E−03 | −3.528E−02 | −1.256E−02 |
| coefficient | | | | | | | | |
| (C) | | | | | | | | |
| 10th | −8.266E−01 | −3.646E−01 | −3.098E−01 | 4.838E−02 | −5.732E−02 | −2.572E−02 | 9.514E−03 | 3.392E−03 |
| order | | | | | | | | |
| coefficient | | | | | | | | |
| (D) | | | | | | | | |
| 12th | 1.749E+00 | 6.085E−01 | 4.097E−01 | −5.078E−02 | 4.903E−02 | 2.008E−02 | −1.861E−03 | −6.748E−04 |
| order | | | | | | | | |
| coefficient | | | | | | | | |
| (E) | | | | | | | | |
| 14th | −2.574E+00 | −6.874E−01 | −3.753E−01 | 4.108E−02 | −2.598E−02 | −8.941E−03 | 2.526E−04 | 1.009E−04 |
| order | | | | | | | | |
| coefficient | | | | | | | | |
| (F) | | | | | | | | |
| 16th | 2.717E+00 | 5.419E−01 | 2.457E−01 | −2.344E−02 | 9.486E−03 | 2.685E−03 | −2.613E−05 | −1.144E−05 |
| order | | | | | | | | |
| coefficient | | | | | | | | |
| (G) | | | | | | | | |
| 18th | −2.089E+00 | −3.023E−01 | −1.164E−01 | 9.301E−03 | −2.460E−03 | −5.726E−04 | 2.032E−06 | 9.838E−07 |
| order | | | | | | | | |
| coefficient | | | | | | | | |
| (H) | | | | | | | | |
| 20th | 1.176E+00 | 1.196E−01 | 3.978E−02 | −2.565E−03 | 4.543E−04 | 8.796E−05 | −1.186E−07 | −6.353E−08 |
| order | | | | | | | | |
| coefficient | | | | | | | | |
| (J) | | | | | | | | |
| 22nd | −4.811E−01 | −3.321E−02 | −9.677E−03 | 4.887E−04 | −5.911E−05 | −9.669E−06 | 5.130E−09 | 3.021E−09 |
| order | | | | | | | | |
| coefficient | | | | | | | | |
| (L) | | | | | | | | |
| 24th | 1.400E−01 | 6.319E−03 | 1.627E−03 | −6.305E−05 | 5.277E−06 | 7.416E−07 | −1.596E−10 | −1.023E−10 |
| order | | | | | | | | |
| coefficient | | | | | | | | |
| (M) | | | | | | | | |
| 26th | −2.755E−02 | −7.827E−04 | −1.791E−04 | 5.256E−06 | −3.070E−07 | −3.767E−08 | 3.375E−12 | 2.326E−12 |
| order | | | | | | | | |
| coefficient | | | | | | | | |
| (N) | | | | | | | | |
| 28th | 3.295E−03 | 5.682E−05 | 1.159E−05 | −2.553E−07 | 1.048E−08 | 1.138E−09 | −4.343E−14 | −3.175E−14 |
| order | | | | | | | | |
| coefficient | | | | | | | | |
| (O) | | | | | | | | |
| 30th | −1.809E−04 | −1.832E−06 | −3.343E−07 | 5.490E−09 | −1.589E−10 | −1.545E−11 | 2.565E−16 | 1.963E−16 |
| order | | | | | | | | |
| coefficient | | | | | | | | |
| (P) | | | | | | | | |

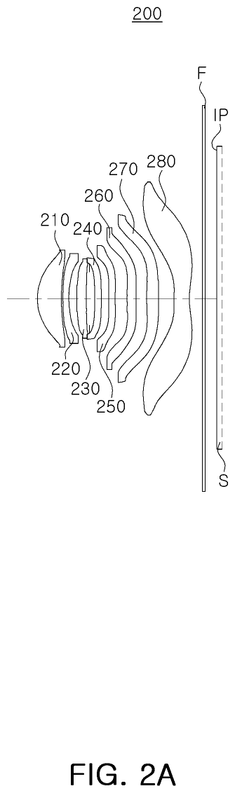

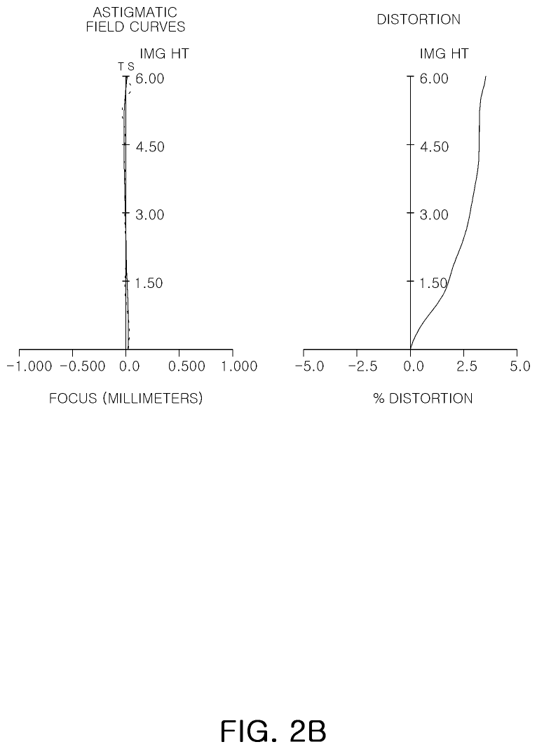

FIG. 2A is a configuration diagram illustrating an optical imaging system according to a second embodiment. FIG. 2B is a graph showing aberration characteristics of the optical imaging system according to the second embodiment.

The optical imaging system 200 according to the second embodiment may include, in order from the object side, a first lens 210, a second lens 220, a third lens 230, a fourth lens 240, a fifth lens 250, a sixth lens 260, a seventh lens 270, and an eighth lens 280.

The first lens 210 may have positive refractive power. An object-side surface of the first lens 210 may be convex in a paraxial region, and an image-side surface of the first lens 210 may be concave in a paraxial region.

The second lens 220 may have negative refractive power. An object-side surface of the second lens 220 may be convex in a paraxial region, and an image-side surface of the second lens 220 may be concave in a paraxial region. The second lens 220 may be a high-index lens having a refractive index of 1.6 or greater.

The third lens 230 may have positive refractive power. An object-side surface of the third lens 230 may be convex in a paraxial region, and an image-side surface of the third lens 230 may be concave in a paraxial region.

The fourth lens 240 may have negative refractive power. An object-side surface of the fourth lens 240 may be concave in a paraxial region, and an image-side surface of the fourth lens 240 may be convex in a paraxial region. The fourth lens 240 may be a high-index lens having a refractive index of 1.6 or greater.

The fifth lens 250 may have negative refractive power. An object-side surface of the fifth lens 250 may be convex in a paraxial region, and an image-side surface of the fifth lens 250 may be concave in a paraxial region. The fifth lens 250 may be a high-index lens having a refractive index of 1.6 or greater.

The sixth lens 260 may have positive refractive power. An object-side surface of the sixth lens 260 may be convex in a paraxial region, and an image-side surface of the sixth lens 260 may be concave in a paraxial region.

The seventh lens 270 may have positive refractive power. An object-side surface of the seventh lens 270 may be convex in a paraxial region, and an image-side surface of the seventh lens 270 may be concave in a paraxial region.

The eighth lens 280 may have negative refractive power. An object-side surface of the eighth lens 280 may be convex in a paraxial region, and an image-side surface of the eighth lens 280 may be concave in a paraxial region.

According to the second embodiment, the Abbe number of each of the first lens 210, the third lens 230, and the eighth lens 280 may be 50 or greater. The Abbe number of each of the second lens 220 and the fourth lens 240 may be less than 20. The Abbe number of each of the fifth lens 250, the sixth lens 260, and the seventh lens 270 may be 20 or greater and 40 or less.

According to the second embodiment, the first lens 210 to the eighth lens 280 may be formed of a plastic material. Also, object-side surfaces and image-side surfaces of the first lens 210 to the eighth lens 280 may be aspherical.

Table 3 lists characteristics of individual lenses included in the optical imaging system 200 according to the second embodiment, and Table 4 lists aspheric coefficients of individual lenses included in the optical imaging system 200 according to the second embodiment.

TABLE 3

| | | Radius of | Thickness/ | Refractive | Abbe | Focal |
|---|---|---|---|---|---|---|
| Surface No. | Notes | curvature | distance | index | number | length |
| Object | | Infinity | Infinity | | | |
| 1 | | Infinity | 0.000 | | | |
| 2 | First lens | 2.209 | 0.922 | 1.544 | 55.99 | 4.973 |
| 3 | | 10.082 | 0.051 | | | |
| 4 | Second lens | 8.773 | 0.230 | 1.671 | 19.40 | −11.939 |
| 5 | | 4.168 | 0.303 | | | |
| 6 | Third lens | 7.942 | 0.363 | 1.544 | 55.99 | 26.045 |
| 7 | | 17.684 | 0.124 | | | |
| 8 | Stop | Infinity | 0.196 | | | |
| 9 | Fourth lens | −54.906 | 0.250 | 1.687 | 18.30 | −143.545 |
| 10 | | −122.253 | 0.290 | | | |
| 11 | Fifth lens | 20.894 | 0.250 | 1.614 | 25.90 | −45.765 |
| 12 | | 12.147 | 0.448 | | | |
| 13 | Sixth lens | 10.053 | 0.350 | 1.587 | 28.40 | 30.753 |
| 14 | | 22.145 | 0.402 | | | |
| 15 | Seventh lens | 8.641 | 0.450 | 1.567 | 37.40 | 18.029 |
| 16 | | 52.909 | 0.597 | | | |
| 17 | Eighth lens | 147.287 | 0.581 | 1.535 | 55.74 | −5.419 |
| 18 | | 2.850 | 0.500 | | | |
| 19 | Filter | Infinity | 0.110 | 1.517 | 64.20 | |
| 20 | | Infinity | 0.404 | | | |
| Image | | Infinity | | | | |

TABLE 4

| Notes | 2 | 3 | 4 | 5 | 6 | 7 | 9 | 10 |
|---|---|---|---|---|---|---|---|---|
| Conic | −0.643 | −17.346 | 23.997 | 3.439 | 21.252 | 10.223 | 99.000 | −72.443 |
| constant | | | | | | | | |
| (K) | | | | | | | | |
| 4th order | 1.224E−02 | −8.643E−03 | −1.533E−02 | −1.739E−02 | −9.450E−03 | −2.029E−02 | −1.461E−02 | −2.323E−02 |
| coefficient | | | | | | | | |
| (A) | | | | | | | | |
| 6th order | −4.069E−02 | 5.153E−02 | 6.877E−03 | 6.087E−02 | −7.827E−02 | 1.144E−01 | −2.011E−01 | −6.940E−02 |
| coefficient | | | | | | | | |
| (B) | | | | | | | | |
| 8th order | 1.688E−01 | −1.670E−01 | 1.429E−01 | −2.347E−01 | 6.412E−01 | −8.374E−01 | 1.501E+00 | 4.854E−01 |
| coefficient | | | | | | | | |
| (C) | | | | | | | | |
| 10th order | −4.330E−01 | 3.943E−01 | −7.378E−01 | 6.434E−01 | −3.130E+00 | 3.850E+00 | −7.310E+00 | −2.132E+00 |
| coefficient | | | | | | | | |
| (D) | | | | | | | | |
| 12th order | 7.511E−01 | −6.510E−01 | 2.042E+00 | −1.088E+00 | 1.002E+01 | −1.187E+01 | 2.381E+01 | 6.110E+00 |
| coefficient | | | | | | | | |
| (E) | | | | | | | | |
| 14th order | −9.157E−01 | 7.588E−01 | −3.648E+00 | 9.996E−01 | −2.196E+01 | 2.556E+01 | −5.411E+01 | −1.207E+01 |
| coefficient | | | | | | | | |
| (F) | | | | | | | | |
| 16th order | 8.018E−01 | −6.349E−01 | 4.470E+00 | −1.037E−01 | 3.385E+01 | −3.933E+01 | 8.792E+01 | 1.690E+01 |
| coefficient | | | | | | | | |
| (G) | | | | | | | | |
| 18th order | −5.097E−01 | 3.850E−01 | −3.861E+00 | −9.742E−01 | −3.728E+01 | 4.371E+01 | −1.034E+02 | −1.698E+01 |
| coefficient(H) | | | | | | | | |
| 20th order | 2.352E−01 | −1.692E−01 | 2.373E+00 | 1.369E+00 | 2.945E+01 | −3.508E+01 | 8.801E+01 | 1.227E+01 |
| coefficient | | | | | | | | |
| (J) | | | | | | | | |
| 22nd order | −7.798E−02 | 5.329E−02 | −1.033E+00 | −1.006E+00 | −1.655E+01 | 2.012E+01 | −5.372E+01 | −6.322E+00 |
| coefficient | | | | | | | | |
| (L) | | | | | | | | |
| 24th order | 1.808E−02 | −1.170E−02 | 3.110E−01 | 4.577E−01 | 6.453E+00 | −8.023E+00 | 2.289E+01 | 2.263E+00 |
| coefficient | | | | | | | | |
| (M) | | | | | | | | |
| 26th order | −2.784E−03 | 1.700E−03 | −6.163E−02 | −1.296E−01 | −1.659E+00 | 2.111E+00 | −6.465E+00 | −5.346E−01 |
| coefficient | | | | | | | | |
| (N) | | | | | | | | |
| 28th order | 2.556E−04 | −1.467E−04 | 7.230E−03 | 2.104E−02 | 2.531E−01 | −3.290E−01 | 1.087E+00 | 7.492E−02 |
| coefficient | | | | | | | | |
| (O) | | | | | | | | |
| 30th order | −1.059E−05 | 5.688E−06 | −3.805E−04 | −1.502E−03 | −1.733E−02 | 2.296E−02 | −8.232E−02 | −4.715E−03 |
| coefficient | | | | | | | | |
| (P) | | | | | | | | |
| Notes | 11 | 12 | 13 | 14 | 15 | 16 | 17 | 18 |
| Conic | −50.483 | −96.437 | −10.911 | 51.639 | −3.158 | 99.000 | 58.111 | −6.829 |
| constant | | | | | | | | |
| (K) | | | | | | | | |
| 4th order | −6.957E−02 | −6.776E−02 | −6.089E−02 | −6.040E−02 | −7.147E−02 | −5.296E−02 | −1.230E−01 | −7.856E−02 |
| coefficient | | | | | | | | |
| (A) | | | | | | | | |
| 6th order | 7.026E−03 | −6.076E−03 | 1.106E−010 | 9.011E−02 | 5.695E−02 | 1.525E−02 | 2.855E−02 | 2.894E−02 |
| coefficient | | | | | | | | |
| (B) | | | | | | | | |
| 8th order | 8.612E−02 | 1.580E−01 | −2.720E−01 | −1.654E−01 | −4.856E−02 | 1.434E−02 | 9.342E−03 | −7.403E−03 |
| coefficient | | | | | | | | |
| (C) | | | | | | | | |
| 10th order | −1.993E−01 | −4.734E−01 | 4.039E−01 | 1.897E−01 | 2.887E−02 | −2.252E−02 | −8.412E−03 | 1.402E−03 |
| coefficient | | | | | | | | |
| (D) | | | | | | | | |
| 12th order | 8.238E−02 | 8.202E−01 | −4.137E−01 | −1.543E−01 | −1.308E−02 | 1.522E−02 | 2.815E−03 | −2.155E−04 |
| coefficient | | | | | | | | |
| (E) | | | | | | | | |
| 14th order | 4.278E−01 | −9.401E−01 | 3.018E−01 | 9.199E−02 | 4.329E−03 | −6.626E−03 | −5.712E−04 | 2.838E−05 |
| coefficient | | | | | | | | |
| (F) | | | | | | | | |
| 16th order | −1.030E+00 | 7.446E−01 | −1.589E−01 | −4.037E−02 | −9.236E−04 | 2.028E−03 | 7.846E−05 | −3.179E−06 |
| coefficient | | | | | | | | |
| (G) | | | | | | | | |
| 18th order | 1.204E+00 | −4.158E−01 | 6.051E−02 | 1.303E−02 | 9.641E−05 | −4.473E−04 | −7.619E−06 | 2.890E−07 |
| coefficient(H) | | | | | | | | |
| 20th order | −8.742E−01 | 1.646E−01 | −1.662E−02 | −3.067E−03 | 4.684E−06 | 7.121E−05 | 5.311E−07 | −2.025E−08 |
| coefficient | | | | | | | | |
| (J) | | | | | | | | |
| 22nd order | 4.172E−01 | −4.586E−02 | 3.255E−03 | 5.187E−04 | −3.009E−06 | −8.086E−06 | −2.649E−08 | 1.047E−09 |
| coefficient | | | | | | | | |
| (L) | | | | | | | | |
| 24th order | −1.309E−01 | 8.771E−03 | −4.426E−04 | −6.116E−05 | 4.368E−07 | 6.375E−07 | 9.241E−10 | −3.814E−11 |
| coefficient | | | | | | | | |
| (M) | | | | | | | | |
| 26th order | 2.592E−02 | −1.095E−03 | 3.971E−05 | 4.761E−06 | −3.278E−08 | −3.312E−08 | −2.144E−11 | 9.202E−13 |
| coefficient | | | | | | | | |
| (N) | | | | | | | | |
| 28th order | −2.923E−03 | 8.034E−05 | −2.114E−06 | −2.195E−07 | 1.298E−09 | 1.019E−09 | 2.973E−13 | −1.314E−14 |
| coefficient | | | | | | | | |
| (O) | | | | | | | | |
| 30th order | 1.420E−04 | −2.626E−06 | 5.056E−08 | 4.532E−09 | −2.149E−11 | −1.406E−11 | −1.865E−15 | 8.382E−17 |
| coefficient | | | | | | | | |
| (P) | | | | | | | | |

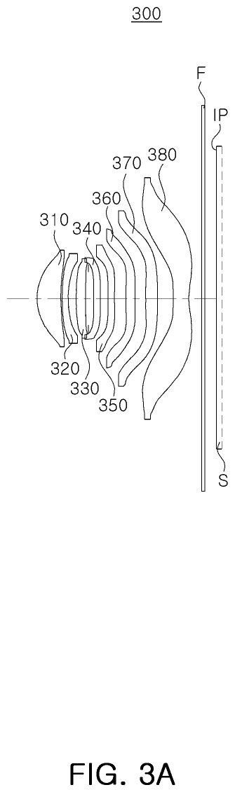

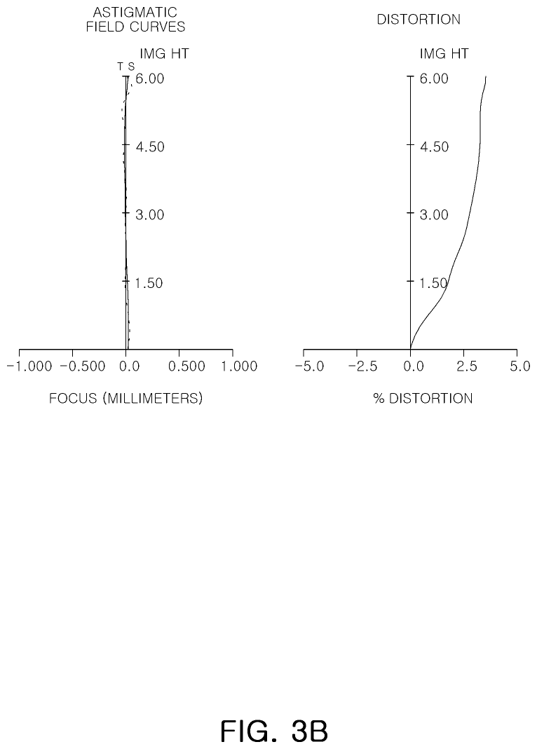

FIG. 3A is a configuration diagram illustrating an optical imaging system according to a third embodiment. FIG. 3B is a graph showing aberration characteristics of the optical imaging system according to the third embodiment.

An optical imaging system 300 according to a third embodiment may include, in order from the object side, a first lens 310, a second lens 320, a third lens 330, a fourth lens 340, a fifth lens 350, a sixth lens 360, a seventh lens 370, and an eighth lens 380.

The first lens 310 may have positive refractive power. An object-side surface of the first lens 310 may be convex in a paraxial region, and an image-side surface of the first lens 310 may be concave in a paraxial region.

The second lens 320 may have negative refractive power. An object-side surface of the second lens 320 may be convex in a paraxial region, and an image-side surface of the second lens 320 may be concave in a paraxial region. The second lens 320 may be a high-index lens having a refractive index of 1.6 or greater.

The third lens 330 may have positive refractive power. An object-side surface of the third lens 330 may be convex in a paraxial region, and an image-side surface of the third lens 330 may be concave in a paraxial region.

The fourth lens 340 may have negative refractive power. Object-side surfaces and image-side surfaces of the fourth lens 340 may be concave in a paraxial region. The fourth lens 340 may be a high-index lens having a refractive index of 1.6 or greater.

The fifth lens 350 may have negative refractive power. An object-side surface of the fifth lens 350 may be convex in a paraxial region, and an image-side surface of the fifth lens 350 may be concave in a paraxial region. The fifth lens 350 may be a high-index lens having a refractive index of 1.6 or greater.

The sixth lens 360 may have positive refractive power. An object-side surface of the sixth lens 360 may be convex in a paraxial region, and an image-side surface of the sixth lens 360 may be concave in a paraxial region.

The seventh lens 370 may have positive refractive power. An object-side surface of the seventh lens 370 may be convex in a paraxial region, and an image-side surface of the seventh lens 370 may be concave in a paraxial region.

The eighth lens 380 may have negative refractive power. An object-side surface of the eighth lens 380 may be convex in a paraxial region, and an image-side surface of the eighth lens 380 may be concave in a paraxial region.

According to a third embodiment, the Abbe number of each of the first lens 310, the third lens 330, and the eighth lens 380 may be 50 or greater. The Abbe number of each of the second lens 320 and the fourth lens 340 may be less than 20. The Abbe number of each of the fifth lens 350, the sixth lens 360, and the seventh lens 370 may be 20 or greater and 40 or less.

According to a third embodiment, the first lens 310 to the eighth lens 380 may be formed of a plastic material. Also, object-side surfaces and image-side surfaces of the first lens 310 to the eighth lens 380 may be aspherical.

Table 5 lists characteristics of individual lenses included in the optical imaging system 300 according to the third embodiment, and Table 6 lists aspheric coefficients of individual lenses included in the optical imaging system 300 according to the third embodiment.

TABLE 5

| | | Radius of | Thickness/ | Refractive | Abbe | Focal |
|---|---|---|---|---|---|---|
| Surface No. | Notes | curvature | distance | index | number | length |
| Object | | Infinity | Infinity | | | |
| 1 | | Infinity | 0.000 | | | |
| 2 | First lens | 2.212 | 0.911 | 1.544 | 55.99 | 4.986 |
| 3 | | 10.058 | 0.050 | | | |
| 4 | Second lens | 8.799 | 0.230 | 1.671 | 19.40 | −11.980 |
| 5 | | 4.182 | 0.300 | | | |
| 6 | Third lens | 8.181 | 0.360 | 1.544 | 55.99 | 27.512 |
| 7 | | 17.673 | 0.112 | | | |
| 8 | Stop | Infinity | 0.210 | | | |
| 9 | Fourth lens | −130.726 | 0.250 | 1.687 | 18.30 | −179.878 |
| 10 | | 2901.229 | 0.288 | | | |
| 11 | Fifth lens | 17.805 | 0.250 | 1.614 | 25.90 | −38.674 |
| 12 | | 10.307 | 0.432 | | | |
| 13 | Sixth lens | 9.126 | 0.352 | 1.587 | 28.40 | 28.133 |
| 14 | | 19.886 | 0.404 | | | |
| 15 | Seventh lens | 7.793 | 0.453 | 1.567 | 37.40 | 16.845 |
| 16 | | 40.262 | 0.609 | | | |
| 17 | Eighth lens | 71.320 | 0.594 | 1.535 | 55.74 | −5.433 |
| 18 | | 2.795 | 0.500 | | | |
| 19 | Filter | Infinity | 0.110 | 1.517 | 64.20 | |
| 20 | | Infinity | 0.408 | | | |
| Image | | Infinity | | | | |

TABLE 6

| Notes | 2 | 3 | 4 | 5 | 6 | 7 | 9 | 10 |
|---|---|---|---|---|---|---|---|---|
| Conic | −0.643 | −16.673 | 23.962 | 3.364 | 22.128 | 12.139 | −45.043 | 99.000 |
| constant | | | | | | | | |
| (K) | | | | | | | | |
| 4th order | 1.095E−02 | −3.699E−03 | −8.452E−03 | −1.327E−02 | −9.020E−03 | −1.996E−02 | −1.835E−02 | −2.397E−02 |
| coefficient | | | | | | | | |
| (A) | | | | | | | | |
| 6th order | −3.036E−02 | 4.708E−02 | −3.138E−03 | 3.422E−02 | −4.832E−02 | 1.016E−01 | −1.633E−01 | −9.464E−02 |
| coefficient | | | | | | | | |
| (B) | | | | | | | | |
| 8th order | 1.266E−01 | −1.801E−01 | 1.216E−01 | −5.745E−02 | 3.116E−01 | −6.754E−01 | 1.272E+00 | 7.737E−01 |
| coefficient | | | | | | | | |
| (C) | | | | | | | | |
| 10th order | −3.244E−01 | 4.505E−01 | −5.668E−01 | −1.533E−01 | −1.315E+00 | 2.844E+00 | −6.393E+00 | −3.554E+00 |
| coefficient | | | | | | | | |
| (D) | | | | | | | | |
| 12th order | 5.613E−01 | −7.672E−01 | 1.508E+00 | 1.235E+00 | 3.861E+00 | −8.098E+00 | 2.131E+01 | 1.029E+01 |
| coefficient | | | | | | | | |
| (E) | | | | | | | | |
| 14th order | −6.795E−01 | 9.127E−01 | −2.637E+00 | −3.597E+00 | −8.021E+00 | 1.622E+01 | −4.936E+01 | −2.017E+01 |
| coefficient | | | | | | | | |
| (F) | | | | | | | | |
| 16th order | 5.878E−01 | −7.736E−01 | 3.198E+00 | 6.272E+00 | 1.199E+01 | −2.330E+01 | 8.145E+01 | 2.774E+01 |
| coefficient | | | | | | | | |
| (G) | | | | | | | | |
| 18th order | −3.673E−01 | 4.722E−01 | −2.753E+00 | −7.274E+00 | −1.301E+01 | 2.418E+01 | −9.690E+01 | −2.725E+01 |
| coefficient(H) | | | | | | | | |
| 20th order | 1.660E−01 | −2.077E−01 | 1.695E+00 | 5.821E+00 | 1.024E+01 | −1.810E+01 | 8.325E+01 | 1.921E+01 |
| coefficient | | | | | | | | |
| (J) | | | | | | | | |
| 22nd order | −5.374E−02 | 6.511E−02 | −7.407E−01 | −3.237E+00 | −5.779E+00 | 9.646E+00 | −5.113E+01 | −9.634E+00 |
| coefficient | | | | | | | | |
| (L) | | | | | | | | |
| 24th order | 1.215E−02 | −1.416E−02 | 2.244E−01 | 1.230E+00 | 2.278E+00 | −3.554E+00 | 2.187E+01 | 3.356E+00 |
| coefficient | | | | | | | | |
| (M) | | | | | | | | |
| 26th order | −1.822E−03 | 2.028E−03 | −4.481E−02 | −3.055E−01 | −5.951E−01 | 8.560E−01 | −6.185E+00 | −7.715E−01 |
| coefficient | | | | | | | | |
| (N) | | | | | | | | |
| 28th order | 1.629E−04 | −1.718E−04 | 5.302E−03 | 4.469E−02 | 9.250E−02 | −1.204E−01 | 1.039E+00 | 1.052E−01 |
| coefficient | | | | | | | | |
| (O) | | | | | | | | |
| 30th order | −6.580E−06 | 6.514E−06 | −2.816E−04 | −2.924E−03 | −6.475E−03 | 7.424E−03 | −7.853E−02 | −6.441E−03 |
| coefficient | | | | | | | | |
| (P) | | | | | | | | |
| Notes | 11 | 12 | 13 | 14 | 15 | 16 | 17 | 18 |
| Conic | −93.804 | −97.047 | −8.595 | 47.109 | −3.220 | 99.000 | −84.089 | −5.959 |
| constant | | | | | | | | |
| (K) | | | | | | | | |
| 4th order | −7.137E−02 | −6.727E−02 | −5.453E−02 | −5.243E−02 | −6.392E−02 | −4.913E−02 | −1.209E−01 | −8.051E−02 |
| coefficient | | | | | | | | |
| (A) | | | | | | | | |
| 6th order | −3.805E−03 | −2.248E−03 | 1.008E−01 | 7.843E−02 | 5.760E−02 | 2.087E−02 | 2.353E−02 | 2.865E−02 |
| coefficient | | | | | | | | |
| (B) | | | | | | | | |
| 8th order | 1.832E−01 | 1.405E−01 | −2.487E−01 | −1.455E−01 | −6.085E−02 | −3.933E−03 | 1.075E−02 | −7.360E−03 |
| coefficient | | | | | | | | |
| (C) | | | | | | | | |
| 10th order | −5.600E−01 | −4.199E−01 | 3.650E−01 | 1.628E−01 | 4.627E−02 | −1.103E−03 | −8.027E−03 | 1.581E−03 |
| coefficient | | | | | | | | |
| (D) | | | | | | | | |
| 12th order | 9.349E−01 | 7.182E−01 | −3.675E−01 | −1.273E−01 | −2.588E−02 | 6.275E−04 | 2.504E−03 | −3.248E−04 |
| coefficient | | | | | | | | |
| (E) | | | | | | | | |
| 14th order | −9.559E−01 | −8.108E−01 | 2.627E−01 | 7.219E−02 | 1.018E−02 | −5.569E−05 | −4.853E−04 | 6.123E−05 |
| coefficient | | | | | | | | |
| (F) | | | | | | | | |
| 16th order | 5.621E−01 | 6.313E−01 | −1.352E−01 | −2.991E−02 | −2.717E−03 | −3.294E−05 | 6.447E−05 | −9.360E−06 |
| coefficient | | | | | | | | |
| (G) | | | | | | | | |
| 18th order | −1.114E−01 | −3.459E−01 | 5.032E−02 | 9.073E−03 | 4.798E−04 | 1.398E−05 | −6.098E−06 | 1.072E−06 |
| coefficient(H) | | | | | | | | |
| 20th order | −9.316E−02 | 1.341E−01 | −1.351E−02 | −2.007E−03 | −5.365E−05 | −2.916E−06 | 4.162E−07 | −8.868E−08 |
| coefficient | | | | | | | | |
| (J) | | | | | | | | |
| 22nd order | 8.771E−02 | −3.653E−025 | 2.587E−03 | 3.192E−04 | 3.312E−06 | 3.930E−07 | −2.039E−08 | 5.186E−09 |
| coefficient | | | | | | | | |
| (L) | | | | | | | | |
| 24th order | −3.489E−02 | 6.817E−03 | −3.443E−04 | −3.543E−05 | −4.077E−08 | −3.545E−08 | 7.003E−10 | −2.082E−10 |
| coefficient | | | | | | | | |
| (M) | | | | | | | | |
| 26th order | 7.632E−03 | −8.287E−04 | 3.025E−05 | 2.601E−06 | −8.906E−09 | 2.055E−09 | −1.063E−11 | 5.451E−12 |
| coefficient | | | | | | | | |
| (N) | | | | | | | | |
| 28th order | −8.823E−04 | 5.904E−05 | −1.578E−06 | −1.131E−07 | 5.915E−10 | −6.887E−11 | 2.196E−13 | −8.370E−14 |
| coefficient | | | | | | | | |
| (O) | | | | | | | | |
| 30th order | 4.131E−05 | −1.869E−06 | 3.702E−08 | 2.204E−09 | −1.218E−11 | 1.009E−12 | −1.363E−15 | 5.713E−16 |
| coefficient | | | | | | | | |
| (P) | | | | | | | | |

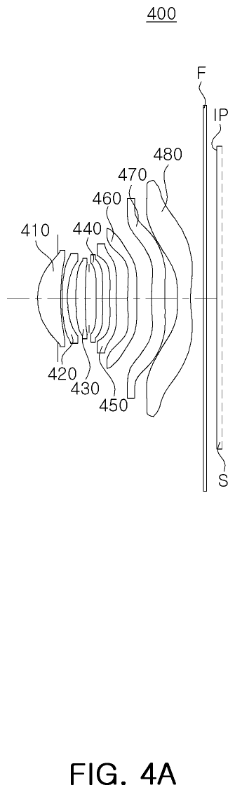

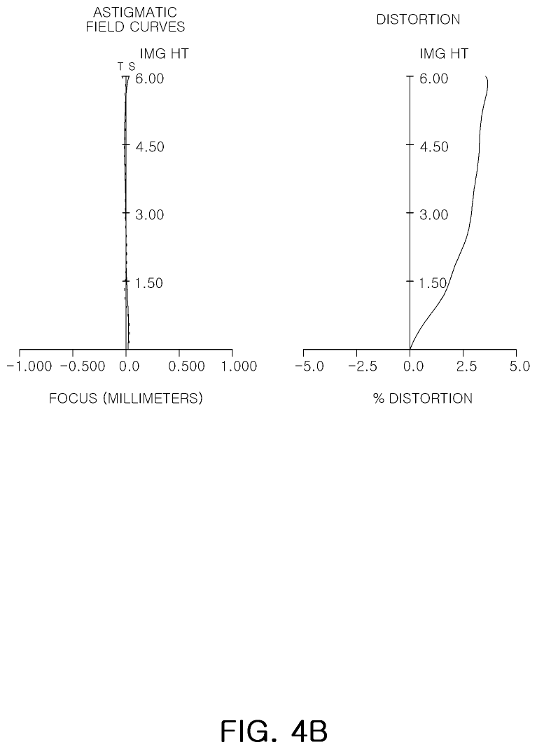

FIG. 4A is a configuration diagram illustrating an optical imaging system according to a fourth embodiment. FIG. 4B is a graph showing aberration characteristics of the optical imaging system according to the fourth embodiment.

An optical imaging system 400 according to a fourth embodiment may include, in order from the object side, a first lens 410, a second lens 420, a third lens 430, a fourth lens 440, a fifth lens 450, a sixth lens 460, a seventh lens 470, and an eighth lens 480.

The first lens 410 may have positive refractive power. An object-side surface of the first lens 410 may be convex in a paraxial region, and an image-side surface of the first lens 410 may be concave in a paraxial region.

The second lens 420 may have negative refractive power. An object-side surface of the second lens 420 may be convex in a paraxial region, and an image-side surface of the second lens 420 may be concave in a paraxial region. The second lens 420 may be a high-index lens having a refractive index of 1.6 or greater.

The third lens 430 may have positive refractive power. An object-side surface of the third lens 430 may be convex in a paraxial region, and an image-side surface of the third lens 430 may be concave in a paraxial region.

The fourth lens 440 may have negative refractive power. An object-side surface of the fourth lens 440 may be convex in a paraxial region, and an image-side surface of the fourth lens 440 may be concave in a paraxial region. The fourth lens 440 may be a high-index lens having a refractive index of 1.6 or greater.

The fifth lens 450 may have negative refractive power. An object-side surface of the fifth lens 450 may be convex in a paraxial region, and an image-side surface of the fifth lens 450 may be concave in a paraxial region. The fifth lens 450 may be a high-index lens having a refractive index of 1.6 or greater.

The sixth lens 460 may have positive refractive power. An object-side surface of the sixth lens 460 may be convex in a paraxial region, and an image-side surface of the sixth lens 460 may be concave in a paraxial region.

The seventh lens 470 may have positive refractive power. An object-side surface of the seventh lens 470 may be convex in a paraxial region, and an image-side surface of the seventh lens 470 may be concave in a paraxial region.

The eighth lens 480 may have negative refractive power. An object-side surface and an image-side surface of the eighth lens 480 may be concave in a paraxial region.

According to the fourth embodiment, the Abbe number of each of the first lens 410, the third lens 430, and the eighth lens 480 may be 50 or greater. The Abbe number of each of the second lens 420 and the fourth lens 440 may be less than 20. The Abbe number of each of the fifth lens 450, the sixth lens 460, and the seventh lens 470 may be 20 or greater and 40 or less.

According to the fourth embodiment, the first lens 410 to the eighth lens 480 may be formed of a plastic material. Also, object-side surfaces and image-side surfaces of the first lens 410 to the eighth lens 480 may be aspherical.

Table 7 lists characteristics of individual lenses included in the optical imaging system 400 according to the fourth embodiment, and Table 8 lists aspheric coefficients of individual lenses included in the optical imaging system 400 according to the fourth embodiment.

TABLE 7

| | | Radius of | Thickness/ | Refractive | Abbe | Focal |
|---|---|---|---|---|---|---|
| Surface No. | Notes | curvature | distance | index | number | length |
| Object | | Infinity | Infinity | | | |
| 1 | | Infinity | −0.773 | | | |
| 2 | First lens | 2.227 | 0.880 | 1.544 | 55.99 | 5.208 |
| 3 | | 8.820 | 0.053 | | | |
| 4 | Second lens | 7.170 | 0.210 | 1.671 | 19.40 | −12.286 |
| 5 | | 3.810 | 0.318 | | | |
| 6 | Third lens | 7.173 | 0.366 | 1.544 | 55.99 | 23.997 |
| 7 | | 15.554 | 0.141 | | | |
| 8 | Stop | Infinity | 0.272 | | | |
| 9 | Fourth lens | 51.394 | 0.250 | 1.687 | 18.30 | −121.196 |
| 10 | | 31.862 | 0.273 | | | |
| 11 | Fifth lens | 14.750 | 0.250 | 1.639 | 23.49 | −64.244 |
| 12 | | 10.808 | 0.431 | | | |
| 13 | Sixth lens | 9.021 | 0.350 | 1.587 | 28.40 | 20.304 |
| 14 | | 35.575 | 0.564 | | | |
| 15 | Seventh lens | 7.344 | 0.506 | 1.567 | 37.40 | 24.865 |
| 16 | | 14.839 | 0.491 | | | |
| 17 | Eighth lens | −13.078 | 0.490 | 1.535 | 55.74 | −5.425 |
| 18 | | 3.798 | 0.500 | | | |
| 19 | Filter | Infinity | 0.110 | 1.517 | 64.20 | |
| 20 | | Infinity | 0.365 | | | |
| Image | | Infinity | | | | |

TABLE 8

| Notes | 2 | 3 | 4 | 5 | 6 | 7 | 9 | 10 |
|---|---|---|---|---|---|---|---|---|
| Conic | −0.637 | −5.864 | 15.671 | 3.306 | 20.793 | −7.012 | 93.872 | −44.489 |
| constant | | | | | | | | |
| (K) | | | | | | | | |
| 4th order | 1.437E−02 | 2.801E−03 | −8.245E−03 | −1.223E−02 | −1.088E−02 | −1.880E−02 | −2.533E−02 | −2.981E−02 |
| coefficient | | | | | | | | |
| (A) | | | | | | | | |
| 6th order | −5.262E−02 | 6.900E−03 | 1.257E−02 | 2.986E−02 | −4.145E−02 | 8.492E−02 | −9.232E−02 | −2.593E−02 |
| coefficient | | | | | | | | |
| (B) | | | | | | | | |
| 8th order | 2.107E−01 | −2.658E−03 | −4.742E−03 | −1.086E−01 | 2.878E−01 | −5.313E−01 | 5.286E−01 | 1.272E−01 |
| coefficient | | | | | | | | |
| (C) | | | | | | | | |
| 10th order | −5.307E−01 | −4.941E−02 | −4.022E−02 | 3.285E−01 | −1.181E+00 | 2.097E+00 | −2.175E+00 | −4.473E−01 |
| coefficient | | | | | | | | |
| (D) | | | | | | | | |
| 12th order | 9.039E−01 | 1.608E−01 | 1.243E−01 | −6.875E−01 | 3.265E+00 | −5.499E+00 | 6.181E+00 | 1.009E+00 |
| coefficient | | | | | | | | |
| (E) | | | | | | | | |
| 14th order | −1.080E+00 | −2.697E−01 | −1.848E−01 | 1.036E+00 | −6.324E+00 | 1.005E+01 | −1.255E+01 | −1.554E+00 |
| coefficient | | | | | | | | |
| (F) | | | | | | | | |
| 16th order | 9.241E−01 | 2.892E−01 | 1.605E−01 | −1.165E+00 | 8.813E+00 | −1.314E+01 | 1.853E+01 | 1.666E+00 |
| coefficient | | | | | | | | |
| (G) | | | | | | | | |
| 18th order | −5.734E−01 | −2.118E−01 | −7.767E−02 | 1.002E+00 | −8.936E+00 | 1.248E+01 | −2.006E+01 | −1.246E+00 |
| coefficient(H) | | | | | | | | |
| 20th order | 2.582E−01 | 1.088E−01 | 1.122E−02 | −6.627E−01 | 6.594E+00 | −8.619E+00 | 1.588E+01 | 6.402E−01 |
| coefficient | | | | | | | | |
| (J) | | | | | | | | |
| 22nd order | −8.355E−02 | −3.936E−02 | 9.917E−03 | 3.309E−01 | −3.501E+00 | 4.286E+00 | −9.076E+00 | −2.154E−01 |
| coefficient | | | | | | | | |
| (L) | | | | | | | | |
| 24th order | 1.893E−02 | 9.860E−03 | −7.019E−03 | −1.198E−01 | 1.302E+00 | −1.494E+00 | 3.642E+00 | 4.189E−02 |
| coefficient | | | | | | | | |
| (M) | | | | | | | | |
| 26th order | −2.852E−03 | −1.634E−03 | 2.099E−03 | 2.931E−02 | −3.217E−01 | 3.459E−01 | −9.728E−01 | −2.661E−03 |
| coefficient | | | | | | | | |
| (N) | | | | | | | | |
| 28th order | 2.567E−04 | 1.619E−04 | −3.182E−04 | −4.300E−03 | 4.744E−02 | −4.772E−02 | 1.551E−01 | −5.197E−04 |
| coefficient | | | | | | | | |
| (O) | | | | | | | | |
| 30th order | −1.045E−05 | −7.294E−06 | 1.993E−05 | 2.831E−04 | −3.159E−03 | 2.959E−03 | −1.117E−02 | 8.290E−05 |
| coefficient | | | | | | | | |
| (P) | | | | | | | | |
| Notes | 11 | 12 | 13 | 14 | 15 | 16 | 17 | 18 |
| Conic | −38.674 | −95.607 | −18.446 | 92.157 | −3.773 | −14.767 | −5.894 | −6.051 |
| constant | | | | | | | | |
| (K) | | | | | | | | |
| 4th order | −6.665E−02 | −5.901E−02 | −3.604E−02 | −2.510E−02 | −3.532E−02 | −9.684E−03 | −7.806E−02 | −6.684E−02 |
| coefficient | | | | | | | | |
| (A) | | | | | | | | |
| 6th order | 1.014E−01 | 5.508E−02 | 6.653E−02 | 2.944E−02 | 3.747E−02 | 4.345E−03 | 1.559E−02 | 1.420E−02 |
| coefficient | | | | | | | | |
| (B) | | | | | | | | |
| 8th order | −3.979E−01 | −1.730E−01 | −1.937E−01 | −8.130E−02 | −7.106E−02 | −2.408E−02 | −3.793E−03 | 1.165E−04 |
| coefficient | | | | | | | | |
| (C) | | | | | | | | |
| 10th order | 1.106E+00 | 4.059E−01 | 2.741E−01 | 9.114E−02 | 6.333E−02 | 2.080E−02 | 3.071E−03 | −9.268E−04 |
| coefficient | | | | | | | | |
| (D) | | | | | | | | |
| 12th order | −2.032E+00 | −6.361E−01 | −2.441E−01 | −6.048E−02 | −3.453E−02 | −9.561E−03 | −1.346E−03 | 2.847E−04 |
| coefficient | | | | | | | | |
| (E) | | | | | | | | |
| 14th order | 2.525E+00 | 6.869E−01 | 1.446E−01 | 2.527E−02 | 1.261E−02 | 2.881E−03 | 3.307E−04 | −5.157E−05 |
| coefficient | | | | | | | | |
| (F) | | | | | | | | |
| 16th order | −2.161E+00 | −5.263E−01 | −5.828E−02 | −6.558E−03 | −3.206E−03 | −6.138E−04 | −5.183E−05 | 6.643E−06 |
| coefficient | | | | | | | | |
| (G) | | | | | | | | |
| 18th order | 1.269E+00 | 2.899E−01 | 1.604E−02 | 9.379E−04 | 5.777E−04 | 9.535E−05 | 5.533E−06 | −6.395E−07 |
| coefficient(H) | | | | | | | | |
| 20th order | −4.934E−01 | −1.149E−01 | −2.950E−03 | −1.976E−05 | −7.424E−05 | −1.087E−05 | −4.138E−07 | 4.601E−08 |
| coefficient | | | | | | | | |
| (J) | | | | | | | | |
| 22nd order | 1.138E−01 | 3.240E−02 | 3.401E−04 | −1.970E−05 | 6.759E−06 | 9.008E−07 | 2.178E−08 | −2.417E−09 |
| coefficient | | | | | | | | |
| (L) | | | | | | | | |
| 24th order | −9.116E−03 | −6.325E−03 | −2.004E−05 | 4.090E−06 | −4.260E−07 | −5.271E−08 | −7.917E−10 | 8.927E−11 |
| coefficient | | | | | | | | |
| (M) | | | | | | | | |
| 26th order | −2.393E−03 | 8.105E−04 | −6.087E−08 | −4.061E−07 | 1.769E−08 | 2.060E−09 | 1.897E−11 | −2.182E−12 |
| coefficient | | | | | | | | |
| (N) | | | | | | | | |
| 28th order | 6.989E−04 | −6.122E−05 | 7.937E−08 | 2.130E−08 | −4.355E−10 | −4.816E−11 | −2.696E−13 | 3.157E−14 |
| coefficient | | | | | | | | |
| (O) | | | | | | | | |
| 30th order | −5.543E−05 | 2.063E−06 | −3.255E−09 | −4.748E−10 | 4.818E−12 | 5.082E−13 | 1.724E−15 | −2.041E−16 |
| coefficient | | | | | | | | |
| (P) | | | | | | | | |

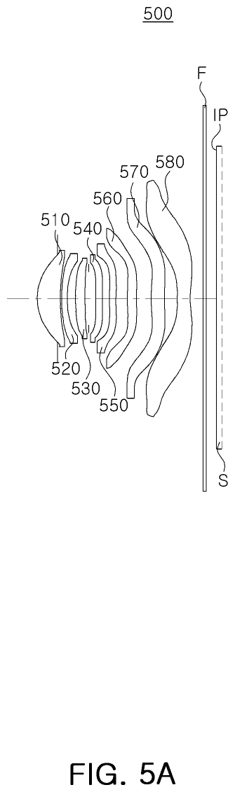

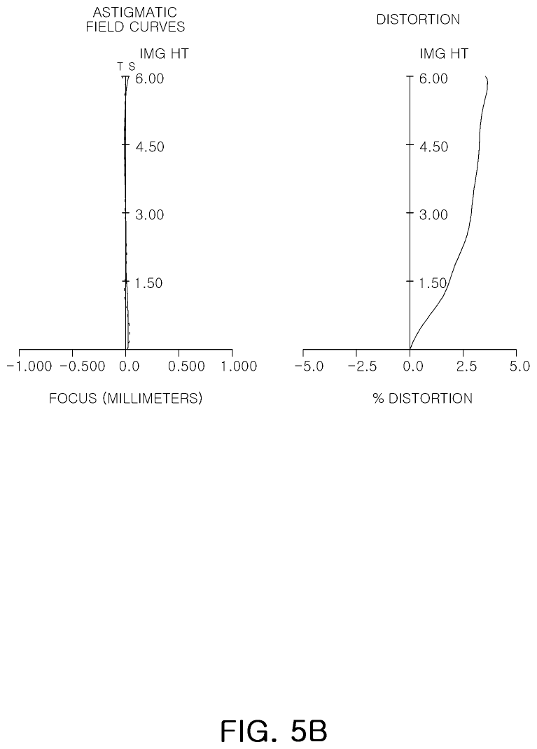

FIG. 5A is a configuration diagram illustrating an optical imaging system according to a fifth embodiment. FIG. 5B is a graph showing aberration characteristics of the optical imaging system according to the fifth embodiment.

An optical imaging system 500 according to a fifth embodiment may include, in order from the object side, a first lens 510, a second lens 520, a third lens 530, a fourth lens 540, a fifth lens 550, a sixth lens 560, a seventh lens 570, and an eighth lens 580.

The first lens 510 may have positive refractive power. An object-side surface of the first lens 510 may be convex in a paraxial region, and an image-side surface of the first lens 510 may be concave in a paraxial region.

The second lens 520 may have negative refractive power. An object-side surface of the second lens 520 may be convex in a paraxial region, and an image-side surface of the second lens 520 may be concave in a paraxial region. The second lens 520 may be a high-index lens having a refractive index of 1.6 or greater.

The third lens 530 may have positive refractive power. An object-side surface of the third lens 530 may be convex in a paraxial region, and an image-side surface of the third lens 530 may be concave in a paraxial region.

The fourth lens 540 may have negative refractive power. An object-side surface of the fourth lens 540 may be convex in a paraxial region, and an image-side surface of the fourth lens 540 may be concave in a paraxial region. The fourth lens 540 may be a high-index lens having a refractive index of 1.6 or greater.

The fifth lens 550 may have negative refractive power. An object-side surface of the fifth lens 550 may be convex in a paraxial region, and an image-side surface of the fifth lens 550 may be concave in a paraxial region. The fifth lens 550 may be a high-index lens having a refractive index of 1.6 or greater.

The sixth lens 560 may have positive refractive power. An object-side surface of the sixth lens 560 may be convex in a paraxial region, and an image-side surface of the sixth lens 560 may be concave in a paraxial region.

The seventh lens 570 may have positive refractive power. An object-side surface of the seventh lens 570 may be convex in a paraxial region, and an image-side surface of the seventh lens 570 may be concave in a paraxial region.

The eighth lens 580 may have negative refractive power. An object-side surface and an image-side surface of the eighth lens 580 may be concave in a paraxial region.

According to the fifth embodiment, the Abbe number of each of the first lens 510, the third lens 530, and the eighth lens 580 may be 50 or greater. The Abbe number of each of the second lens 520 and the fourth lens 540 may be less than 20. The Abbe number of each of the fifth lens 550, the sixth lens 560, and the seventh lens 570 may be 20 or greater and 40 or less.

According to the fifth embodiment, the first lens 510 to the eighth lens 580 may be formed of a plastic material. Also, object-side surfaces and image-side surfaces of the first lens 510 to the eighth lens 580 may be aspherical.

Table 9 lists characteristics of individual lenses included in the optical imaging system 500 according to the fifth embodiment, and Table 10 lists aspheric coefficients of individual lenses included in the optical imaging system 500 according to the fifth embodiment.

TABLE 9

| | | Radius of | Thickness/ | Refractive | Abbe | Focal |
|---|---|---|---|---|---|---|
| Surface No. | Notes | curvature | distance | index | number | length |
| Object | | Infinity | Infinity | | | |
| 1 | | Infinity | −0.772 | | | |
| 2 | First lens | 2.227 | 0.880 | 1.544 | 55.99 | 5.208 |
| 3 | | 8.813 | 0.053 | | | |
| 4 | Second lens | 7.163 | 0.210 | 1.671 | 19.40 | −12.288 |
| 5 | | 3.808 | 0.319 | | | |
| 6 | Third lens | 7.173 | 0.365 | 1.544 | 55.99 | 24.047 |
| 7 | | 15.514 | 0.141 | | | |
| 8 | Stop | Infinity | 0.272 | | | |
| 9 | Fourth lens | 51.805 | 0.250 | 1.687 | 18.30 | −110.847 |
| 10 | | 30.921 | 0.273 | | | |
| 11 | Fifth lens | 14.700 | 0.250 | 1.639 | 23.49 | −69.533 |
| 12 | | 11.000 | 0.431 | | | |
| 13 | Sixth lens | 9.070 | 0.350 | 1.587 | 28.40 | 20.369 |
| 14 | | 36.003 | 0.564 | | | |
| 15 | Seventh lens | 7.321 | 0.503 | 1.567 | 37.40 | 25.148 |
| 16 | | 14.568 | 0.495 | | | |
| 17 | Eighth lens | −13.158 | 0.490 | 1.535 | 55.74 | −5.439 |
| 18 | | 3.804 | 0.500 | | | |
| 19 | Filter | Infinity | 0.110 | 1.517 | 64.20 | |
| 20 | | Infinity | 0.365 | | | |
| Image | | Infinity | | | | |

TABLE 10

| Notes | 2 | 3 | 4 | 5 | 6 | 7 | 9 | 10 |
|---|---|---|---|---|---|---|---|---|
| Conic | −0.637 | −5.903 | 15.671 | 3.308 | 20.786 | −5.382 | 97.470 | −46.686 |
| constant | | | | | | | | |
| (K) | | | | | | | | |
| 4th order | 1.412E−02 | 2.813E−03 | −8.067E−03 | −1.254E−02 | −1.077E−02 | −1.945E−02 | −2.498E−02 | −2.809E−02 |
| coefficient | | | | | | | | |
| (A) | | | | | | | | |
| 6th order | −5.047E−02 | 6.891E−03 | 9.047E−03 | 3.079E−02 | −4.316E−02 | 9.689E−02 | −9.594E−02 | −4.422E−02 |
| coefficient | | | | | | | | |
| (B) | | | | | | | | |
| 8th order | 2.008E−01 | −1.009E−03 | 1.731E−02 | −1.109E−01 | 2.939E−01 | −6.371E−01 | 5.542E−01 | 2.272E−01 |
| coefficient | | | | | | | | |
| (C) | | | | | | | | |
| 10th order | −5.032E−01 | −5.781E−02 | −1.169E−01 | 3.306E−01 | −1.185E+00 | 2.652E+00 | −2.308E+00 | −7.933E−01 |
| coefficient | | | | | | | | |
| (D) | | | | | | | | |
| 12th order | 8.533E−01 | 1.832E−01 | 2.984E−01 | −6.723E−01 | 3.230E+00 | −7.386E+00 | 6.661E+00 | 1.821E+00 |
| coefficient | | | | | | | | |
| (E) | | | | | | | | |
| 14th order | −1.015E+00 | −3.091E−01 | −4.596E−01 | 9.632E−01 | −6.199E+00 | 1.443E+01 | −1.373E+01 | −2.895E+00 |
| coefficient | | | | | | | | |
| (F) | | | | | | | | |
| 16th order | 8.647E−01 | 3.374E−01 | 4.711E−01 | −1.005E+00 | 8.596E+00 | −2.032E+01 | 2.057E+01 | 3.258E+00 |
| coefficient | | | | | | | | |
| (G) | | | | | | | | |
| 18th order | −5.338E−01 | −2.538E−01 | −3.323E−01 | 7.899E−01 | −8.704E+00 | 2.087E+01 | −2.254E+01 | −2.623E+00 |
| coefficient | | | | | | | | |
| (H) | | | | | | | | |
| 20th order | 2.390E−01 | 1.348E−01 | 1.625E−01 | −4.774E−01 | 6.432E+00 | −1.566E+01 | 1.802E+01 | 1.508E+00 |
| coefficient | | | | | | | | |
| (J) | | | | | | | | |
| 22nd order | −7.682E−02 | −5.076E−02 | −5.456E−02 | 2.218E−01 | −3.426E+00 | 8.485E+00 | −1.038E+01 | −6.090E−01 |
| coefficient | | | | | | | | |
| (L) | | | | | | | | |
| 24th order | 1.727E−02 | 1.331E−02 | 1.217E−02 | −7.667E−02 | 1.279E+00 | −3.230E+00 | 4.193E+00 | 1.671E−01 |
| coefficient | | | | | | | | |
| (M) | | | | | | | | |
| 26th order | −2.580E−03 | −2.321E−03 | −1.685E−03 | 1.837E−02 | −3.176E−01 | 8.188E−01 | −1.125E+00 | −2.917E−02 |
| coefficient | | | | | | | | |
| (N) | | | | | | | | |
| 28th order | 2.301E−04 | 2.427E−04 | 1.20E−04 | −2.682E−03 | 4.705E−02 | −1.240E−01 | 1.800E−01 | 2.831E−03 |
| coefficient | | | | | | | | |
| (O) | | | | | | | | |
| 30th order | −9.277E−06 | −1.155E−05 | −3.572E−06 | 1.772E−04 | −3.148E−03 | 8.468E−03 | −1.299E−02 | −1.084E−04 |
| coefficient | | | | | | | | |
| (P) | | | | | | | | |
| Notes | 11 | 12 | 13 | 14 | 15 | 16 | 17 | 18 |
| Conic | −39.479 | −98.756 | −18.799 | 91.586 | −3.769 | −14.783 | −5.316 | −6.148 |
| constant | | | | | | | | |
| (K) | | | | | | | | |
| 4th order | −6.661E−02 | −5.937E−02 | −3.490E−02 | −2.396E−02 | −3.746E−02 | −1.309E−02 | −7.895E−02 | −6.632E−02 |
| coefficient | | | | | | | | |
| (A) | | | | | | | | |
| 6th order | 1.058E−01 | 6.068E−02 | 6.311E−02 | 2.646E−02 | 4.424E−02 | 1.220E−02 | 1.687E−02 | 1.381E−02 |
| coefficient | | | | | | | | |
| (B) | | | | | | | | |
| 8th order | −4.235E−01 | −2.006E−01 | −1.908E−01 | −7.886E−02 | −8.199E−02 | −3.401E−02 | −4.593E−03 | 3.868E−04 |
| coefficient | | | | | | | | |
| (C) | | | | | | | | |
| 10th order | 1.177E+00 | 4.755E−01 | 2.748E−01 | 9.096E−02 | 7.350E−02 | 2.848E−02 | 3.358E−03 | −1.049E−03 |
| coefficient | | | | | | | | |
| (D) | | | | | | | | |
| 12th order | −2.144E+00 | −7.437E−01 | −2.477E−01 | −6.155E−02 | −4.035E−02 | −1.338E−02 | −1.413E−03 | 3.174E−04 |
| coefficient | | | | | | | | |
| (E) | | | | | | | | |
| 14th order | 2.626E+00 | 7.973E−01 | 1.483E−01 | 2.612E−02 | 1.479E−02 | 4.154E−03 | 3.414E−04 | −5.677E−05 |
| coefficient | | | | | | | | |
| (F) | | | | | | | | |
| 16th order | −2.204E+00 | −6.047E−01 | −6.062E−02 | −6.895E−03 | −3.762E−03 | −9.103E−04 | −5.308E−05 | 7.137E−06 |
| coefficient | | | | | | | | |
| (G) | | | | | | | | |
| 18th order | 1.259E+00 | 3.293E−01 | 1.704E−02 | 1.015E−03 | 6.772E−04 | 1.445E−04 | 5.643E−06 | −6.648E−07 |
| coefficient | | | | | | | | |
| (H) | | | | | | | | |
| 20th order | −4.684E−01 | −1.290E−01 | −3.255E−03 | −2.956E−05 | −8.687E−05 | −1.671E−05 | −4.211E−07 | 4.624E−08 |
| coefficient | | | | | | | | |
| (J) | | | | | | | | |
| 22nd order | 9.807E−02 | 3.597E−02 | 4.068E−04 | −1.930E−05 | 7.893E−06 | 1.394E−06 | 2.214E−08 | −2.361E−09 |
| coefficient | | | | | | | | |
| (L) | | | | | | | | |
| 24th order | −3.585E−03 | −6.950E−03 | −3.018E−05 | 4.161E−06 | −4.965E−07 | −8.162E−08 | −8.047E−10 | 8.543E−11 |
| coefficient | | | | | | | | |
| (M) | | | | | | | | |
| 26th order | −3.543E−03 | 8.823E−04 | 9.489E−07 | −4.185E−07 | 2.057E−08 | 3.178E−09 | 1.929E−11 | −2.062E−12 |
| coefficient | | | | | | | | |
| (N) | | | | | | | | |
| 28th order | 8.316E−04 | −6.610E−05 | 2.030E−08 | 2.210E−08 | −5.055E−10 | −7.375E−11 | −2.744E−13 | 2.964E−14 |
| coefficient | | | | | | | | |
| (O) | | | | | | | | |
| 30th order | −6.198E−05 | 2.212E−06 | −1.723E−09 | −4.945E−10 | 5.582E−12 | 7.708E−13 | 1.756E−15 | −1.915E−16 |
| coefficient | | | | | | | | |
| (P) | | | | | | | | |

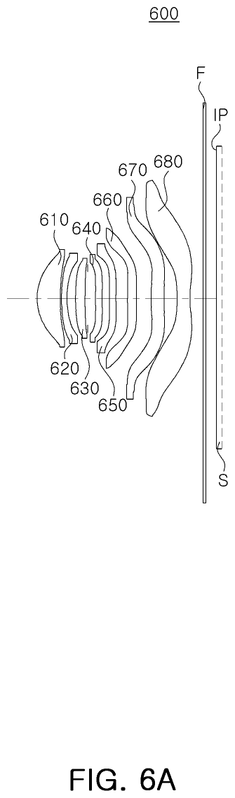

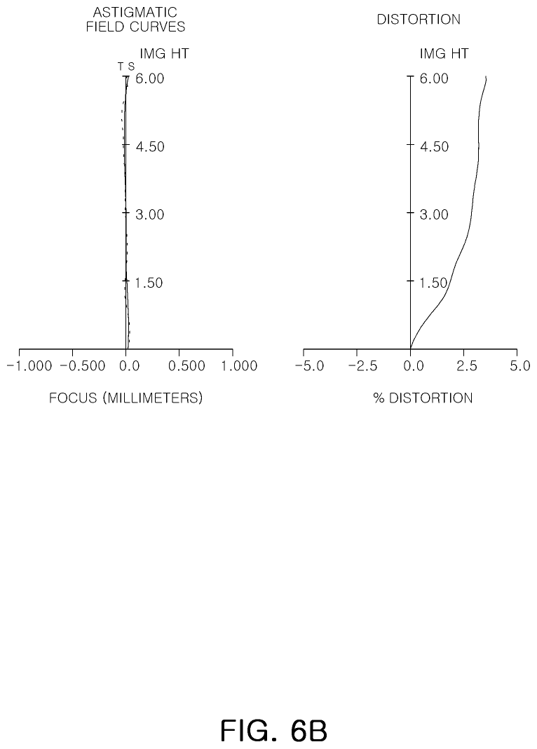

FIG. 6A is a configuration diagram illustrating an optical imaging system according to a sixth embodiment. FIG. 6B is a graph showing aberration characteristics of an optical imaging system according to the sixth embodiment.

An optical imaging system 600 according to a sixth embodiment may include, in order from the object side, a first lens 610, a second lens 620, a third lens 630, a fourth lens 640, a fifth lens 650, a sixth lens 660, a seventh lens 670, and an eighth lens 680.

The first lens 610 may have positive refractive power. An object-side surface of the first lens 610 may be convex in a paraxial region, and an image-side surface of the first lens 610 may be concave in a paraxial region.

The second lens 620 may have negative refractive power. An object-side surface of the second lens 620 may be convex in a paraxial region, and an image-side surface of the second lens 620 may be concave in a paraxial region. The second lens 620 may be a high-index lens having a refractive index of 1.6 or greater.

The third lens 630 may have positive refractive power. An object-side surface of the third lens 630 may be convex in a paraxial region, and an image-side surface of the third lens 630 may be concave in a paraxial region.

The fourth lens 640 may have negative refractive power. An object-side surface of the fourth lens 640 may be convex in a paraxial region, and an image-side surface of the fourth lens 640 may be concave in a paraxial region. The fourth lens 640 may be a high-index lens having a refractive index of 1.6 or greater.

The fifth lens 650 may have negative refractive power. An object-side surface of the fifth lens 650 may be convex in a paraxial region, and an image-side surface of the fifth lens 650 may be concave in a paraxial region. The fifth lens 650 may be a high-index lens having a refractive index of 1.6 or greater.

The sixth lens 660 may have positive refractive power. An object-side surface of the sixth lens 660 may be convex in a paraxial region, and an image-side surface of the sixth lens 660 may be concave in a paraxial region.

The seventh lens 670 may have positive refractive power. An object-side surface of the seventh lens 670 may be convex in a paraxial region, and an image-side surface of the seventh lens 670 may be concave in a paraxial region.

The eighth lens 680 may have negative refractive power. An object-side surface and an image-side surface of the eighth lens 680 may be concave in a paraxial region.

According to the sixth embodiment, the Abbe number of each of the first lens 610, the third lens 630 and the eighth lens 680 may be 50 or greater. The Abbe number of each of the second lens 620 and the fourth lens 640 may be less than 20. The Abbe number of each of the fifth lens 650, the sixth lens 660 and the seventh lens 670 may be 20 or greater and 40 or less.

According to the sixth embodiment, the first lens 610 to the eighth lens 680 may be formed of a plastic material. Also, object-side surfaces and image-side surfaces of the first lens 610 to the eighth lens 680 may be aspherical.

Table 11 lists characteristics of individual lenses included in the optical imaging system 600 according to the sixth embodiment, and Table 12 lists aspheric coefficients of individual lenses included in the optical imaging system 600 according to the sixth embodiment.

TABLE 11

| Surface | | Radius of | Thickness/ | Refractive | Abbe | Focal |
|---|---|---|---|---|---|---|
| No. | Notes | curvature | distance | index | number | length |
| Object | | Infinity | Infinity | | | |
| 1 | | Infinity | 0.000 | | | |
| 2 | First lens | 2.227 | 0.884 | 1.544 | 55.99 | 5.207 |
| 3 | | 8.824 | 0.049 | | | |
| 4 | Second lens | 7.141 | 0.210 | 1.671 | 19.40 | −12.300 |
| 5 | | 3.803 | 0.323 | | | |
| 6 | Third lens | 7.164 | 0.364 | 1.544 | 55.99 | 24.156 |
| 7 | | 15.390 | 0.111 | | | |
| 8 | Stop | Infinity | 0.300 | | | |
| 9 | Fourth lens | 45.998 | 0.250 | 1.687 | 18.30 | −100.750 |
| 10 | | 27.706 | 0.268 | | | |
| 11 | Fifth lens | 14.961 | 0.250 | 1.639 | 23.49 | −82.077 |
| 12 | | 11.590 | 0.441 | | | |
| 13 | Sixth lens | 9.328 | 0.350 | 1.587 | 28.40 | 20.434 |
| 14 | | 40.109 | 0.557 | | | |
| 15 | Seventh lens | 7.257 | 0.499 | 1.567 | 37.40 | 27.845 |
| 16 | | 13.022 | 0.500 | | | |
| 17 | Eighth lens | −13.989 | 0.491 | 1.535 | 55.74 | −5.554 |
| 18 | | 3.838 | 0.500 | | | |
| 19 | Filter | Infinity | 0.110 | 1.517 | 64.20 | |
| 20 | | Infinity | 0.364 | | | |
| Image | | Infinity | | | | |

TABLE 12

| Notes | 2 | 3 | 4 | 5 | 6 | 7 | 9 | 10 |
|---|---|---|---|---|---|---|---|---|
| Conic | −0.637 | −6.162 | 15.665 | 3.311 | 20.800 | −12.657 | −98.913 | −42.560 |
| constant | | | | | | | | |
| (K) | | | | | | | | |
| 4th order | 1.345E−02 | 1.270E−03 | −6.367E−03 | −9.965E−03 | −1.147E−02 | −1.813E−02 | −2.402E−02 | −2.875E−02 |
| coefficient | | | | | | | | |
| (A) | | | | | | | | |
| 6th order | −4.482E−02 | −1.019E−02 | −4.933E−02 | −2.657E−02 | −1.745E−02 | 1.021E−01 | −1.117E−01 | −4.266E−02 |
| coefficient | | | | | | | | |
| (B) | | | | | | | | |
| 8th order | 1.717E−01 | 9.990E−02 | 3.831E−01 | 3.312E−01 | 8.748E−02 | −7.557E−01 | 6.689E−01 | 2.508E−01 |
| coefficient | | | | | | | | |
| (C) | | | | | | | | |
| 10th order | −4.180E−01 | −3.280E−01 | −1.318E+00 | −1.433E+00 | −2.500E−01 | 3.484E+00 | −2.747E+00 | −9.680E−01 |
| coefficient | | | | | | | | |
| (D) | | | | | | | | |
| 12th order | 6.974E−01 | 6.355E−01 | 2.827E+00 | 3.734E+00 | 5.348E−01 | −1.068E+01 | 7.665E+00 | 2.408E+00 |
| coefficient | | | | | | | | |
| (E) | | | | | | | | |
| 14th order | −8.262E−01 | −8.306E−01 | −4.149E+00 | −6.530E+00 | −9.511E−01 | 2.283E+01 | −1.516E+01 | −4.103E+00 |
| coefficient | | | | | | | | |
| (F) | | | | | | | | |
| 16th order | 7.087E−01 | 7.687E−01 | 4.337E+00 | 8.042E+00 | 1.445E+00 | −3.490E+01 | 2.175E+01 | 4.937E+00 |
| coefficient | | | | | | | | |
| (G) | | | | | | | | |
| 18th order | −4.440E−01 | −5.135E−01 | −3.285E+00 | −7.126E+00 | −1.757E+00 | 3.863E+01 | −2.289E+01 | −4.256E+00 |
| coefficient | | | | | | | | |
| (H) | | | | | | | | |
| 20th order | 2.029E−01 | 2.485E−01 | 1.809E+00 | 4.568E+00 | 1.594E+00 | −3.098E+01 | 1.765E+01 | 2.635E+00 |
| coefficient | | | | | | | | |
| (J) | | | | | | | | |
| 22nd order | −6.688E−02 | −8.637E−02 | −7.164E−01 | −2.100E+00 | −1.028E+00 | 1.780E+01 | −9.851E+00 | −1.160E+00 |
| coefficient | | | | | | | | |
| (L) | | | | | | | | |
| 24th order | 1.546E−02 | 2.101E−02 | 1.989E−01 | 6.754E−01 | 4.542E−01 | −7.129E+00 | 3.871E+00 | 3.534E−01 |
| coefficient | | | | | | | | |
| (M) | | | | | | | | |
| 26th order | −2.379E−03 | −3.397E−03 | −3.671E−02 | −1.444E−01 | −1.300E−01 | 1.889E+00 | −1.015E+00 | −7.062E−02 |
| coefficient | | | | | | | | |
| (N) | | | | | | | | |
| 28th order | 2.186E−04 | 3.282E−04 | 4.046E−03 | 1.844E−02 | 2.173E−02 | −2.972E−01 | 1.592E−01 | 8.288E−03 |
| coefficient | | | | | | | | |
| (O) | | | | | | | | |
| 30th order | −9.084E−06 | −1.435E−05 | −2.015E−04 | −1.066E−03 | −1.609E−03 | 2.101E−02 | −1.129E−02 | −4.305E−04 |
| coefficient | | | | | | | | |
| (P) | | | | | | | | |
| Notes | 11 | 12 | 13 | 14 | 15 | 16 | 17 | 18 |
| Conic | −27.404 | −79.559 | −19.829 | 61.087 | −3.864 | −17.845 | −3.870 | −6.499 |
| constant | | | | | | | | |
| (K) | | | | | | | | |
| 4th order | −7.469E−02 | −6.832E−02 | −4.457E−02 | −3.359E−02 | −4.460E−02 | −1.998E−02 | −7.603E−02 | −6.249E−02 |
| coefficient | | | | | | | | |
| (A) | | | | | | | | |
| 6th order | 1.775E−01 | 1.054E−01 | 9.829E−02 | 5.873E−02 | 5.754E−02 | 2.078E−02 | 9.021E−03 | 1.036E−02 |
| coefficient | | | | | | | | |
| (B) | | | | | | | | |
| 8th order | −7.461E−01 | −3.276E−01 | −2.492E−01 | −1.234E−01 | −8.768E−02 | −3.524E−02 | 2.420E−03 | 1.509E−03 |
| coefficient | | | | | | | | |
| (C) | | | | | | | | |
| 10th order | 2.134E+00 | 7.103E−01 | 3.322E−01 | 1.267E−01 | 7.070E−02 | 2.522E−02 | 1.673E−04 | −1.111E−03 |
| coefficient | | | | | | | | |
| (D) | | | | | | | | |
| 12th order | −4.125E+00 | −1.048E+00 | −2.841E−01 | −8.046E−02 | −3.627E−02 | −1.065E−02 | −5.275E−04 | 2.584E−04 |
| coefficient | | | | | | | | |
| (E) | | | | | | | | |
| 14th order | 5.556E+00 | 1.083E+00 | 1.630E−01 | 3.329E−02 | 1.271E−02 | 3.030E−03 | 1.772E−04 | −3.662E−05 |
| coefficient | | | | | | | | |
| (F) | | | | | | | | |
| 16th order | −5.339E+00 | −8.041E−01 | −6.397E−02 | −9.041E−03 | −3.130E−03 | −6.168E−04 | −3.172E−05 | 3.750E−06 |
| coefficient | | | | | | | | |
| (G) | | | | | | | | |
| 18th order | 3.701E+00 | 4.327E−01 | 1.713E−02 | 1.569E−03 | 5.499E−04 | 9.210E−05 | 3.646E−06 | −3.068E−07 |
| coefficient | | | | | | | | |
| (H) | | | | | | | | |
| 20th order | −1.850E+00 | −1.686E−01 | −3.047E−03 | −1.542E−04 | −6.913E−05 | −1.013E−05 | −2.858E−07 | 2.078E−08 |
| coefficient | | | | | | | | |
| (J) | | | | | | | | |
| 22nd order | 6.586E−01 | 4.696E−02 | 3.326E−04 | 3.132E−06 | 6.169E−06 | 8.126E−07 | 1.554E−08 | −1.120E−09 |
| coefficient | | | | | | | | |
| (L) | | | | | | | | |
| 24th order | −1.622E−01 | −9.091E−03 | −1.679E−05 | 1.241E−06 | −3.815E−07 | −4.610E−08 | −5.794E−10 | 4.451E−11 |
| coefficient | | | | | | | | |
| (M) | | | | | | | | |
| 26th order | 2.616E−02 | 1.159E−03 | −4.559E−07 | −1.676E−07 | 1.555E−08 | 1.750E−09 | 1.415E−11 | −1.188E−12 |
| coefficient | | | | | | | | |
| (N) | | | | | | | | |
| 28th order | −2.472E−03 | −8.732E−05 | 1.018E−07 | 9.520E−09 | −3.759E−10 | −3.975E−11 | −2.044E−13 | 1.878E−14 |
| coefficient | | | | | | | | |
| (O) | | | | | | | | |
| 30th order | 1.031E−04 | 2.940E−06 | −3.748E−09 | −2.166E−10 | 4.081E−12 | 4.078E−13 | 1.324E−15 | −1.319E−16 |
| coefficient | | | | | | | | |
| (P) | | | | | | | | |

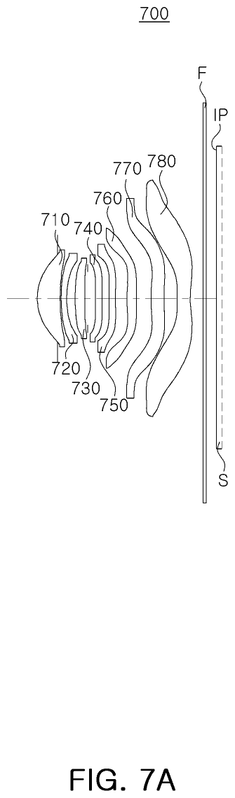

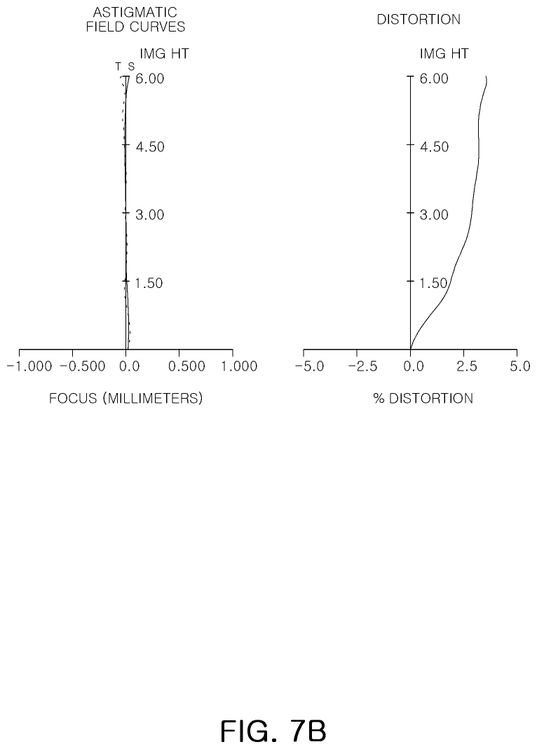

FIG. 7A is a configuration diagram illustrating an optical imaging system according to a seventh embodiment. FIG. 7B is a graph showing aberration characteristics of the optical imaging system according to the seventh embodiment.

An optical imaging system 700 according to a seventh embodiment may include, in order from the object side, a first lens 710, a second lens 720, a third lens 730, a fourth lens 740, a fifth lens 750, a sixth lens 760, a seventh lens 770, and an eighth lens 780.

The first lens 710 may have positive refractive power. An object-side surface of the first lens 710 may be convex in a paraxial region, and an image-side surface of the first lens 710 may be concave in a paraxial region.

The second lens 720 may have negative refractive power. An object-side surface of the second lens 720 may be convex in a paraxial region, and an image-side surface of the second lens 720 may be concave in a paraxial region. The second lens 720 may be a high-index lens having a refractive index of 1.6 or greater.

The third lens 730 may have positive refractive power. An object-side surface of the third lens 730 may be convex in a paraxial region, and an image-side surface of the third lens 730 may be concave in a paraxial region.

The fourth lens 740 may have negative refractive power. An object-side surface of the fourth lens 740 may be convex in a paraxial region, and an image-side surface of the fourth lens 740 may be concave in a paraxial region. The fourth lens 740 may be a high-index lens having a refractive index of 1.6 or greater.

The fifth lens 750 may have negative refractive power. An object-side surface of the fifth lens 750 may be convex in a paraxial region, and an image-side surface of the fifth lens 750 may be concave in a paraxial region. The fifth lens 750 may be a high-index lens having a refractive index of 1.6 or greater.

The sixth lens 760 may have positive refractive power. An object-side surface of the sixth lens 760 may be convex in a paraxial region, and an image-side surface of the sixth lens 760 may be concave in a paraxial region.

The seventh lens 770 may have positive refractive power. An object-side surface of the seventh lens 770 may be convex in a paraxial region, and an image-side surface of the seventh lens 770 may be concave in a paraxial region.

The eighth lens 780 may have negative refractive power. An object-side surface and an image-side surface of the eighth lens 780 may be concave in a paraxial region.

According to the seventh embodiment, the Abbe number of each of the first lens 710, the third lens 730, and the eighth lens 780 may be 50 or greater. The Abbe number of each of the second lens 720 and the fourth lens 740 may be less than 20. The Abbe number of each of the fifth lens 750, the sixth lens 760, and the seventh lens 770 may be 20 or greater and 40 or less.

According to the seventh embodiment, the first lens 710 to the eighth lens 780 may be formed of a plastic material. Also, object-side surfaces and image-side surfaces of the first lens 710 to the eighth lens 780 may be aspherical.

Table 13 lists characteristics of individual lenses included in the optical imaging system 700 according to the seventh embodiment, and Table 14 lists aspheric coefficients of individual lenses included in the optical imaging system 700 according to the seventh embodiment.

TABLE 13

| Surface | | Radius of | Thickness/ | Refractive | Abbe | Focal |
|---|---|---|---|---|---|---|
| No. | Notes | curvature | distance | index | number | length |
| Object | | Infinity | Infinity | | | |
| 1 | | Infinity | −0.772 | | | |
| 2 | First lens | 2.224 | 0.870 | 1.544 | 55.99 | 5.212 |
| 3 | | 8.756 | 0.041 | | | |
| 4 | Second lens | 7.095 | 0.210 | 1.671 | 19.40 | −12.367 |
| 5 | | 3.799 | 0.322 | | | |
| 6 | Third lens | 7.176 | 0.367 | 1.544 | 55.99 | 24.820 |
| 7 | | 14.969 | 0.112 | | | |
| 8 | Stop | Infinity | 0.301 | | | |
| 9 | Fourth lens | 39.165 | 0.250 | 1.687 | 18.30 | −101.029 |
| 10 | | 25.081 | 0.264 | | | |
| 11 | Fifth lens | 14.248 | 0.250 | 1.639 | 23.49 | −83.710 |
| 12 | | 11.198 | 0.445 | | | |
| 13 | Sixth lens | 9.027 | 0.352 | 1.587 | 28.40 | 19.871 |
| 14 | | 38.175 | 0.567 | | | |
| 15 | Seventh lens | 7.270 | 0.497 | 1.567 | 37.40 | 29.841 |
| 16 | | 12.368 | 0.509 | | | |
| 17 | Eighth lens | −14.404 | 0.490 | 1.535 | 55.74 | −5.624 |
| 18 | | 3.867 | 0.500 | | | |
| 19 | Filter | Infinity | 0.110 | 1.517 | 64.20 | |
| 20 | | Infinity | 0.364 | | | |
| Image | | Infinity | | | | |

TABLE 14

| Notes | 2 | 3 | 4 | 5 | 6 | 7 | 9 | 10 |
|---|---|---|---|---|---|---|---|---|
| Conic | −0.644 | −5.158 | 15.615 | 3.320 | 20.844 | −17.009 | −26.702 | −13.518 |
| constant | | | | | | | | |
| (K) | | | | | | | | |
| 4th order | 1.435E−02 | 2.748E−03 | −4.670E−03 | −1.142E−02 | −1.213E−02 | −1.538E−02 | −2.211E−02 | −2.625E−02 |
| coefficient | | | | | | | | |
| (A) | | | | | | | | |
| 6th order | −5.238E−02 | −2.563E−02 | −7.028E−02 | −8.720E−03 | −2.642E−02 | 5.511E−02 | −1.364E−01 | −7.034E−02 |
| coefficient | | | | | | | | |
| (B) | | | | | | | | |
| 8th order | 2.084E−01 | 1.661E−01 | 4.915E−01 | 1.846E−01 | 1.841E−01 | −3.999E−01 | 8.283E−01 | 3.875E−01 |
| coefficient | | | | | | | | |
| (C) | | | | | | | | |
| 10th order | −5.225E−01 | −4.693E−01 | −1.645E+00 | −7.998E−01 | −7.613E−01 | 1.820E+00 | −3.484E+00 | −1.418E+00 |
| coefficient | | | | | | | | |
| (D) | | | | | | | | |
| 12th order | 8.906E−01 | 8.014E−01 | 3.512E+00 | 2.113E+00 | 2.237E+00 | −5.475E+00 | 1.011E+01 | 3.469E+00 |
| coefficient | | | | | | | | |
| (E) | | | | | | | | |
| 14th order | −1.071E+00 | −9.218E−01 | −5.199E+00 | −3.868E+00 | −4.773E+00 | 1.151E+01 | −2.091E+01 | −5.915E+00 |
| coefficient | | | | | | | | |
| (F) | | | | | | | | |
| 16th order | 9.283E−01 | 7.444E−01 | 5.527E+00 | 5.124E+00 | 7.443E+00 | −1.742E+01 | 3.141E+01 | 7.190E+00 |
| coefficient | | | | | | | | |
| (G) | | | | | | | | |
| 18th order | −5.863E−01 | −4.274E−01 | −4.278E+00 | −4.976E+00 | −8.458E+00 | 1.920E+01 | −3.453E+01 | −\|6.296E+00 |
| coefficient | | | | | | | | |
| (H) | | | | | | | | |
| 20th order | 2.698E−01 | 1.736E−01 | 2.412E+00 | 3.533E+00 | 6.948E+00 | −1.542E+01 | 2.770E+01 | 3.974E+00 |
| coefficient | | | | | | | | |
| (J) | | | | | | | | |
| 22nd order | −8.942E−02 | −4.877E−02 | −9.796E−01 | −1.809E+00 | −4.065E+00 | 8.916E+00 | −1.601E+01 | −1.789E+00 |
| coefficient | | | | | | | | |
| (L) | | | | | | | | |
| 24th order | 2.079E−02 | 9.016E−03 | 2.789E−01 | 6.490E−01 | 1.647E+00 | −3.607E+00 | 6.486E+00 | 5.589E−01 |
| coefficient | | | | | | | | |
| (M) | | | | | | | | |
| 26th order | −3.215E−03 | −9.923E−04 | −5.280E−02 | −1.546E−01 | −4.386E−01 | 9.675E−01 | −1.745E+00 | −1.149E−01 |
| coefficient | | | | | | | | |
| (N) | | | | | | | | |
| 28th order | 2.971E−04 | 5.069E−05 | 5.965E−03 | 2.194E−02 | 6.897E−02 | −1.543E−01 | 2.798E−01 | 1.396E−02 |
| coefficient | | | | | | | | |
| (O) | | | | | | | | |
| 30th order | −1.241E−05 | −2.648E−07 | −3.044E−04 | −1.405E−03 | −4.850E−03 | 1.107E−02 | −2.022E−02 | −7.566E−04 |
| coefficient | | | | | | | | |
| (P) | | | | | | | | |
| Notes | 11 | 12 | 13 | 14 | 15 | 16 | 17 | 18 |
| Conic | −19.774 | −65.149 | −19.632 | 43.383 | −3.831 | −18.614 | −3.450 | −6.349 |
| constant | | | | | | | | |
| (K) | | | | | | | | |
| 4th order | −7.443E−02 | −6.728E−02 | −4.316E−02 | −3.017E−02 | −4.143E−02 | −1.867E−02 | −7.470E−02 | −6.184E−02 |
| coefficient | | | | | | | | |
| (A) | | | | | | | | |
| 6th order | 1.692E−01 | 9.042E−02 | 9.669E−02 | 4.689E−02 | 4.672E−02 | 1.561E−02 | 7.208E−03 | 9.367E−03 |
| coefficient | | | | | | | | |
| (B) | | | | | | | | |
| 8th order | −7.046E−01 | −2.664E−01 | −2.634E−01 | −1.080E−01 | −7.391E−02 | −2.945E−02 | 4.308E−03 | 2.434E−03 |
| coefficient | | | | | | | | |
| (C) | | | | | | | | |
| 10th order | 2.017E+00 | 5.685E−01 | 3.791E−01 | 1.181E−01 | 6.092E−02 | 2.197E−02 | −9.398E−04 | −1.634E−03 |
| coefficient | | | | | | | | |
| (D) | | | | | | | | |
| 12th order | −3.907E+00 | −8.322E−01 | −3.531E−01 | −8.088E−02 | −3.186E−02 | −9.573E−03 | −1.448E−04 | 4.412E−04 |
| coefficient | | | | | | | | |
| (E) | | | | | | | | |
| 14th order | 5.276E+00 | 8.577E−01 | 2.244E−01 | 3.729E−02 | 1.138E−02 | 2.810E−03 | 9.233E−05 | −7.840E−05 |
| coefficient | | | | | | | | |
| (F) | | | | | | | | |
| 16th order | −5.087E+00 | −6.367E−01 | −1.001E−01 | −1.250E−02 | −2.856E−03 | −5.899E−04 | −1.896E−05 | 1.026E−05 |
| coefficient | | | | | | | | |
| (G) | | | | | | | | |
| 18th order | 3.541E+00 | 3.437E−01 | 3.185E−02 | 2.828E−03 | 5.110E−04 | 9.068E−05 | 2.301E−06 | −1.015E−06 |
| coefficient | | | | | | | | |
| (H) | | | | | | | | |
| 20th order | −1.778E+00 | −1.347E−01 | −7.245E−03 | −4.966E−04 | −6.536E−05 | −1.024E−05 | −1.852E−07 | 7.508E−08 |
| coefficient | | | | | | | | |
| (J) | | | | | | | | |
| 22nd order | 6.367E−01 | 3.778E−02 | 1.170E−03 | 6.601E−05 | 5.932E−06 | 8.402E−07 | 1.020E−08 | −4.044E−09 |
| coefficient | | | | | | | | |
| (L) | | | | | | | | |
| 24th order | −1.579E−01 | −7.371E−03 | −1.313E−04 | −6.520E−06 | −3.730E−07 | −4.860E−08 | −3.827E−10 | 1.526E−10 |
| coefficient | | | | | | | | |
| (M) | | | | | | | | |
| 26th order | 2.566E−02 | 9.471E−04 | 9.772E−06 | 4.501E−07 | 1.545E−08 | 1.875E−09 | 9.370E−12 | −3.801E−12 |
| coefficient | | | | | | | | |
| (N) | | | | | | | | |
| 28th order | −2.449E−03 | −7.189E−05 | −4.356E−07 | −1.915E−08 | −3.795E−10 | −4.323E−11 | −1.353E−13 | 5.595E−14 |
| coefficient | | | | | | | | |
| (O) | | | | | | | | |
| 30th order | 1.034E−04 | 2.437E−06 | 8.852E−09 | 3.732E−10 | 4.188E−12 | 4.494E−13 | 8.744E−16 | −3.678E−16 |
| coefficient | | | | | | | | |
| (P) | | | | | | | | |

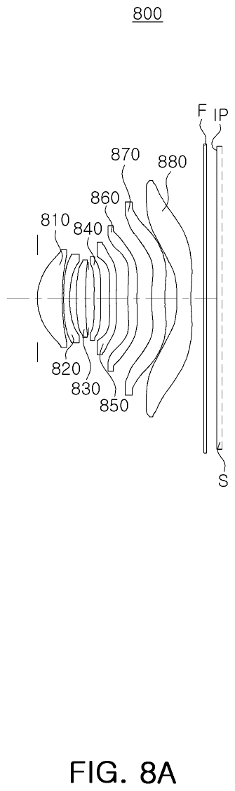

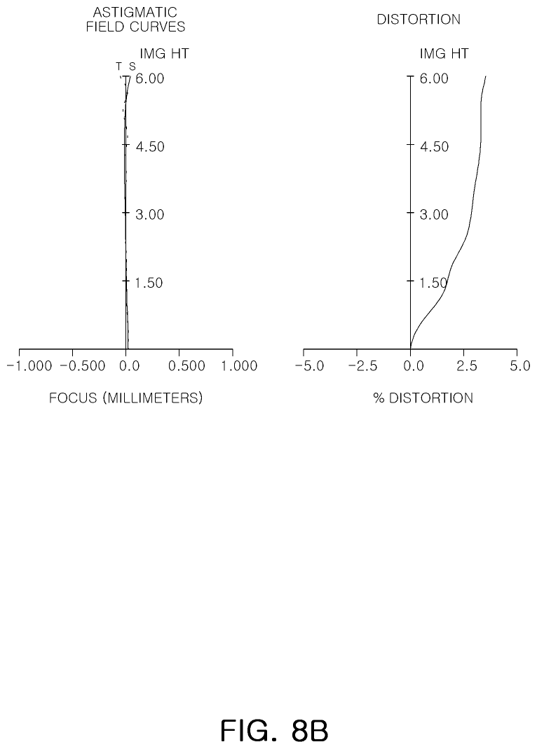

FIG. 8A is a configuration diagram illustrating an optical imaging system according to an eighth embodiment. FIG. 8B is a graph showing aberration characteristics of the optical imaging system according to the eighth embodiment.

An optical imaging system 800 according to an eighth embodiment may include, in order from the object side, a first lens 810, a second lens 820, a third lens 830, a fourth lens 840, a fifth lens 850, a sixth lens 860, a seventh lens 870, and an eighth lens 880.

The first lens 810 may have positive refractive power. An object-side surface of the first lens 810 may be convex in a paraxial region, and an image-side surface of the first lens 810 may be concave in a paraxial region.

The second lens 820 may have negative refractive power. An object-side surface of the second lens 820 may be convex in a paraxial region, and an image-side surface of the second lens 820 may be concave in a paraxial region. The second lens 820 may be a high-index lens having a refractive index of 1.6 or greater.

The third lens 830 may have positive refractive power. An object-side surface of the third lens 830 may be convex in a paraxial region, and an image-side surface of the third lens 830 may be concave in a paraxial region.

The fourth lens 840 may have negative refractive power. An object-side surface of the fourth lens 840 may be convex in a paraxial region, and an image-side surface of the fourth lens 840 may be concave in a paraxial region. The fourth lens 840 may be a high-index lens having a refractive index of 1.6 or greater.

The fifth lens 850 may have negative refractive power. An object-side surface of the fifth lens 850 may be convex in a paraxial region, and an image-side surface of the fifth lens 850 may be concave in a paraxial region. The fifth lens 850 may be a high-index lens having a refractive index of 1.6 or greater.

The sixth lens 860 may have positive refractive power. An object-side surface of the sixth lens 860 may be convex in a paraxial region, and an image-side surface of the sixth lens 860 may be concave in a paraxial region.

The seventh lens 870 may have positive refractive power. An object-side surface of the seventh lens 870 may be convex in a paraxial region, and an image-side surface of the seventh lens 870 may be concave in a paraxial region.

The eighth lens 880 may have negative refractive power. An object-side surface and an image-side surface of the eighth lens 880 may be concave in a paraxial region.

According to the eighth embodiment, the Abbe number of each of the first lens 810, the third lens 830, and the eighth lens 880 may be 50 or greater. The Abbe number of each of the second lens 820 and the fourth lens 840 may be less than 20. The Abbe number of each of the fifth lens 850, the sixth lens 860, and the seventh lens 770 may be 20 or greater, 40 or less.

According to the eighth embodiment, the first lens 810 to the eighth lens 880 may be formed of a plastic material. Also, object-side surfaces and image-side surfaces of the first lens 810 to the eighth lens 880 may be aspherical.

Table 15 lists characteristics of individual lenses included in the optical imaging system 800 according to the eighth embodiment, and Table 16 lists aspheric coefficients of individual lenses included in the optical imaging system 800 according to the eighth embodiment.

TABLE 15

| Surface | | Radius of | Thickness/ | Refractive | Abbe | Focal |
|---|---|---|---|---|---|---|
| No. | Notes | curvature | distance | index | number | length |
| Object | | Infinity | Infinity | | | |
| 1 | | Infinity | 0.000 | | | |
| 2 | First lens | 2.226 | 0.948 | 1.544 | 55.99 | 5.128 |
| 3 | | 9.210 | 0.050 | | | |
| 4 | Second lens | 7.877 | 0.230 | 1.671 | 19.40 | −11.375 |
| 5 | | 3.853 | 0.257 | | | |
| 6 | Third lens | 6.915 | 0.359 | 1.544 | 55.99 | 24.538 |
| 7 | | 14.020 | 0.112 | | | |
| 8 | Stop | Infinity | 0.214 | | | |
| 9 | Fourth lens | 53.316 | 0.250 | 1.687 | 18.30 | −861.413 |
| 10 | | 48.864 | 0.344 | | | |
| 11 | Fifth lens | 17.985 | 0.250 | 1.639 | 23.49 | −96.708 |
| 12 | | 13.887 | 0.444 | | | |
| 13 | Sixth lens | 9.265 | 0.350 | 1.587 | 28.40 | 32.899 |
| 14 | | 17.415 | 0.553 | | | |
| 15 | Seventh lens | 4.397 | 0.516 | 1.567 | 37.40 | 28.338 |
| 16 | | 5.781 | 0.460 | | | |
| 17 | Eighth lens | −7.731 | 0.532 | 1.535 | 55.74 | −6.345 |
| 18 | | 6.241 | 0.500 | | | |
| 19 | Filter | Infinity | 0.110 | 1.517 | 64.20 | |
| 20 | | Infinity | 0.341 | | | |
| Image | | Infinity | | | | |

TABLE 16

| Notes | 2 | 3 | 4 | 5 | 6 | 7 | 9 | 10 |
|---|---|---|---|---|---|---|---|---|
| Conic | −0.629 | −7.960 | 17.265 | 3.253 | 19.001 | 1.575 | −98.785 | −71.560 |
| constant | | | | | | | | |
| (K) | | | | | | | | |
| 4th order | 9.808E−03 | −2.247E−04 | −7.369E−03 | −1.276E−02 | −1.086E−02 | −1.474E−02 | −2.169E−02 | −2.406E−02 |
| coefficient | | | | | | | | |
| (A) | | | | | | | | |
| 6th order | −2.904E−02 | 2.163E−02 | 1.067E−02 | 4.379E−02 | −5.848E−02 | 2.435E−02 | −1.843E−01 | −1.094E−01 |
| coefficient | | | | | | | | |
| (B) | | | | | | | | |
| 8th order | 1.248E−01 | −8.606E−02 | −8.259E−03 | −2.081E−01 | 4.674E−01 | −8.351E−02 | 1.490E+00 | 7.177E−01 |
| coefficient | | | | | | | | |
| (C) | | | | | | | | |
| 10th order | −3.239E−01 | 2.348E−01 | 1.144E−02 | 7.684E−01 | −2.203E+00 | 6.944E−02 | −7.450E+00 | −2.880E+00 |
| coefficient | | | | | | | | |
| (D) | | | | | | | | |
| 12th order | 5.628E−01 | −4.594E−01 | −6.249E−02 | −1.978E+00 | 6.824E+00 | 6.756E−01 | 2.451E+01 | 7.609E+00 |
| coefficient | | | | | | | | |
| (E) | | | | | | | | |
| 14th order | −6.831E−01 | 6.419E−01 | 1.820E−01 | 3.617E+00 | −1.454E+01 | − 3.243E+00 | −5.555E+01 | −1.390E+01 |
| coefficient | | | | | | | | |
| (F) | | | | | | | | |
| 16th order | 5.933E−01 | −6.433E−01 | −2.949E−01 | −4.778E+00 | 2.193E+01 | 7.609E+00 | 8.911E+01 | 1.804E+01 |
| coefficient | | | | | | | | |
| (G) | | | | | | | | |
| 18th order | −3.733E−01 | 4.648E−01 | 3.022E−01 | 4.596E+00 | −2.376E+01 | −1.126E+01 | −1.027E+02 | −1.685E+01 |
| coefficient | | | | | | | | |
| (H) | | | | | | | | |
| 20th order | 1.705E−01 | −2.419E−01 | −2.069E−01 | −3.211E+00 | 1.855E+01 | 1.126E+01 | 8.519E+01 | 1.137E+01 |
| coefficient | | | | | | | | |
| (J) | | | | | | | | |
| 22nd order | −5.589E−02 | 8.965E−02 | 9.623E−02 | 1.607E+00 | −1.034E+01 | 7.728E+00 | −5.046E+01 | −5.482E+00 |
| coefficient | | | | | | | | |
| (L) | | | | | | | | |
| 24th order | 1.282E−02 | −2.305E−02 | −3.007E−02 | −5.595E−01 | 4.014E+00 | 3.601E+00 | 2.080E+01 | 1.842E+00 |
| coefficient | | | | | | | | |
| (M) | | | | | | | | |
| 26th order | −1.953E−03 | 3.902E−03 | 6.041E−03 | 1.281E−01 | −1.030E+00 | −1.090E+00 | −5.666E+00 | −4.097E−01 |
| coefficient | | | | | | | | |
| (N) | | | | | | | | |
| 28th order | 1.774E−04 | −3.907E−04 | −7.047E−04 | −1.726E−02 | 1.571E−01 | 1.937E−01 | 9.168E−01 | 5.416E−02 |
| coefficient | | | | | | | | |
| (O) | | | | | | | | |
| 30th order | −7.269E−06 | 1.750E−05 | 3.620E−05 | 1.032E−03 | −1.077E−02 | −1.533E−02 | −6.672E−02 | −3.221E−03 |
| coefficient | | | | | | | | |
| (P) | | | | | | | | |
| Notes | 11 | 12 | 13 | 14 | 15 | 16 | 17 | 18 |
| Conic | −13.735 | −66.163 | −11.455 | 12.102 | −6.816 | −58.616 | −99.000 | −3.482 |
| constant | | | | | | | | |
| (K) | | | | | | | | |
| 4th order | −3.457E−02 | −3.260E−02 | −2.234E−02 | −3.439E−02 | −6.229E−02 | −1.547E−03 | −4.356E−02 | −1.947E−02 |
| coefficient | | | | | | | | |
| (A) | | | | | | | | |
| 6th order | −6.731E−02 | −3.274E−02 | 2.147E−02 | 2.286E−02 | 3.951E−02 | −3.613E−02 | −5.127E−02 | −3.428E−02 |
| coefficient | | | | | | | | |
| (B) | | | | | | | | |
| 8th order | 2.354E−01 | 6.182E−02 | −6.049E−02 | −2.538E−02 | −5.312E−02 | 2.414E−02 | 5.122E−02 | 2.873E−02 |
| coefficient | | | | | | | | |
| (C) | | | | | | | | |
| 10th order | −6.079E−01 | −6.729E−02 | 7.393E−02 | 9.578E−03 | 4.766E−02 | −1.037E−02 | −2.124E−02 | −1.157E−02 |
| coefficient | | | | | | | | |
| (D) | | | | | | | | |
| 12th order | 1.229E+00 | 3.824E−02 | −5.927E−02 | 4.338E−03 | −2.859E−02 | 3.635E−03 | 5.296E−03 | 2.948E−03 |
| coefficient | | | | | | | | |
| (E) | | | | | | | | |
| 14th order | −1.934E+00 | 4.893E−03 | 3.254E−02 | −7.395E−03 | 1.165E−02 | −1.073E−03 | −8.863E−04 | −5.190E−04 |
| coefficient | | | | | | | | |
| (F) | | | | | | | | |
| 16th order | 2.313E+00 | −3.075E−02 | −1.249E−02 | 4.418E−03 | −3.266E−03 | 2.527E−04 | 1.047E−04 | 6.559E−05 |
| coefficient | | | | | | | | |
| (G) | | | | | | | | |
| 18th order | −2.062E+00 | 2.949E−02 | 3.359E−03 | −1.572E−03 | 6.377E−04 | −4.492E−05 | −8.937E−06 | −6.041E−06 |
| coefficient | | | | | | | | |
| (H) | | | | | | | | |
| 20th order | 1.348E+00 | −1.605E−02 | −6.214E−04 | 3.697E−04 | −8.743E−05 | 5.826E−06 | 5.555E−07 | 4.060E−07 |
| coefficient | | | | | | | | |
| (J) | | | | | | | | |
| 22nd order | −6.333E−01 | 5.614E−03 | 7.610E−05 | −5.933E−05 | 8.384E−06 | −5.376E−07 | −2.495E−08 | −1.967E−08 |
| coefficient | | | | | | | | |
| (L) | | | | | | | | |
| 24th order | 2.071E−01 | −1.281E−03 | −5.693E−06 | 6.475E−06 | −5.509E−0 | 3.423E−08 | 7.900E−10 | 6.683E−10 |
| coefficient | | | | | | | | |
| (M) | | | | | | | | |
| 26th order | −4.464E−02 | 1.843E−04 | 2.091E−07 | −4.628E−07 | 2.365E−08 | −1.427E−09 | −1.674E−11 | −1.509E−11 |
| coefficient | | | | | | | | |
| (N) | | | | | | | | |
| 28th order | 5.687E−03 | −1.519E−05 | −1.205E−10 | 1.964E−08 | −5.977E−10 | 3.505E−11 | 2.134E−13 | 2.030E−13 |
| coefficient | | | | | | | | |
| (O) | | | | | | | | |
| 30th order | −3.237E−04 | 5.457E−07 | 1.656E−10 | −3.766E−10 | 6.748E−12 | −3.842E−13 | −1.237E−15 | −1.232E−15 |
| coefficient | | | | | | | | |
| (P) | | | | | | | | |

Table 17 lists optical and physical characteristics of the optical imaging system according to embodiments, and Table 18 lists values of conditional expressions according to embodiments.

TABLE 17

| | First | Second | Third | Fourth |
|---|---|---|---|---|
| Notes | embodiment | embodiment | embodiment | embodiment |
| f | 6.272 | 6.267 | 6.232 | 6.257 |
| IMH | 12.240 | 12.240 | 12.240 | 12.240 |
| FOV | 85.280 | 85.280 | 85.600 | 85.440 |
| FNO | 1.780 | 1.788 | 1.780 | 1.788 |
| OAL | 6.820 | 6.820 | 6.821 | 6.820 |
| BFL | 1.026 | 1.014 | 1.018 | 0.975 |
| | Fifth | Sixth | Seventh | Eighth |
| Notes | embodiment | embodiment | embodiment | embodiment |
| f | 6.257 | 6.257 | 6.257 | 6.237 |
| IMH | 12.240 | 12.240 | 12.240 | 12.240 |
| FOV | 85.440 | 85.410 | 85.420 | 85.590 |
| FNO | 1.788 | 1.789 | 1.789 | 1.788 |
| OAL | 6.820 | 6.820 | 6.820 | 6.821 |
| BFL | 0.975 | 0.974 | 0.974 | 0.951 |

TABLE 18

| | First | Second | Third | Fourth |
|---|---|---|---|---|
| Notes | embodiment | embodiment | embodiment | embodiment |
| FOV × IMH/f | 166.432 | 166.562 | 168.126 | 167.133 |
| OAL/IMH | 0.557 | 0.557 | 0.557 | 0.557 |
| FNO × (OAL/IMH) | 0.992 | 0.996 | 0.992 | 0.996 |
| V1 − V2 | 36.590 | 36.590 | 36.590 | 36.590 |
| V1 − V4 | 36.590 | 37.690 | 37.690 | 37.690 |
| V1 − (V6 + V7)/2 | 23.090 | 23.090 | 23.090 | 23.090 |
| f1/f | 0.792 | 0.794 | 0.800 | 0.832 |
| f2/f | −1.861 | −1.905 | −1.922 | −1.963 |
| \| f3/f \| | 4.687 | 4.156 | 4.415 | 3.835 |
| \| f4/f \| /10 | 6.594 | 2.291 | 2.886 | 1.937 |
| f5/f | −5.917 | −7.303 | −6.206 | −10.267 |
| f6/f | 5.225 | 4.907 | 4.514 | 3.245 |
| f7/f | 2.453 | 2.877 | 2.703 | 3.974 |
| f8/f | −0.826 | −0.865 | −0.872 | −0.867 |
| f1/f2 | −0.426 | −0.417 | −0.416 | −0.424 |
| f1/f3 | 0.169 | 0.191 | 0.181 | 0.217 |
| OAL/f | 1.087 | 1.088 | 1.094 | 1.090 |
| BFL/f | 0.164 | 0.162 | 0.163 | 0.156 |
| D1/f | 0.008 | 0.008 | 0.008 | 0.009 |
| | Fifth | Sixth | Seventh | Eighth |
| Notes | embodiment | embodiment | embodiment | embodiment |
| FOV × IMH/f | 167.133 | 167.077 | 167.089 | 167.958 |
| OAL/IMH | 0.557 | 0.557 | 0.557 | 0.557 |
| FNO × (OAL/IMH) | 0.996 | 0.997 | 0.997 | 0.996 |
| V1 − V2 | 36.590 | 36.590 | 36.590 | 36.590 |
| V1 − V4 | 37.690 | 37.690 | 37.690 | 37.690 |
| V1 − (V6 + V7)/2 | 23.090 | 23.090 | 23.090 | 23.090 |
| f1/f | 0.832 | 0.832 | 0.833 | 0.822 |
| f2/f | −1.964 | −1.966 | −1.976 | −1.824 |
| \| f3/f \| | 3.843 | 3.861 | 3.967 | 3.934 |
| \| f4/f \| /10 | 1.771 | 1.610 | 1.615 | 13.810 |
| f5/f | −11.112 | −13.117 | −13.378 | −15.504 |
| f6/f | 3.255 | 3.266 | 3.176 | 5.274 |
| f7/f | 4.019 | 4.450 | 4.769 | 4.543 |
| f8/f | −0.869 | −0.888 | −0.899 | −1.017 |
| f1/f2 | −0.424 | −0.423 | −0.421 | −0.451 |
| f1/f3 | 0.217 | 0.216 | 0.210 | 0.209 |
| OAL/f | 1.090 | 1.090 | 1.090 | 1.094 |
| BFL/f | 0.156 | 0.156 | 0.156 | 0.152 |
| D1/f | 0.008 | 0.008 | 0.007 | 0.008 |

According to the aforementioned embodiments, a reduced thickness may be implemented, and high-quality images may be obtained.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens having positive refractive power;
a second lens having negative refractive power;
a third lens having refractive power;
a fourth lens having refractive power;
a fifth lens having negative refractive power;
a sixth lens having positive refractive power;
a seventh lens having refractive power; and
an eighth lens having negative refractive power,
wherein the first to eighth lenses are disposed in order from an object side, and
wherein 0.8<FNO×(OAL/IMH)≤1.0 is satisfied,
where FNO is a value (F-number) representing a brightness of the optical imaging system, OAL is a distance on an optical axis from an object-side surface of the first lens to an imaging plane, and IMH is a diagonal length of the imaging plane.

2. The optical imaging system of claim 1, wherein the third lens has positive refractive power, and an image-side surface is concave.

3. The optical imaging system of claim 1, wherein the fourth lens has negative refractive power.

4. The optical imaging system of claim 1, wherein the fourth lens has a convex object-side surface and a concave image-side surface.

5. The optical imaging system of claim 1,
wherein the seventh lens has positive refractive power, and
wherein 2<f7/f<5 is satisfied,
where f7 is a focal length of the seventh lens, and f is a total focal length of the optical imaging system.

6. The optical imaging system of claim 1, wherein the eighth lens has a convex object-side surface.

7. The optical imaging system of claim 1, wherein 0<f1/f<1 is satisfied,
where f1 is a focal length of the first lens, and f is a total focal length of the optical imaging system.

8. The optical imaging system of claim 1, wherein 150°<FOV×IMH/f<180° is satisfied,
where FOV is a field of view of the optical imaging system, and f is a total focal length of the optical imaging system.

9. The optical imaging system of claim 1, wherein 1.0<OAL/f<1.2 is satisfied,
where f is a total focal length of the optical imaging system.

10. The optical imaging system of claim 1, wherein 10<V1−(V6+V7)/2<30 is satisfied,
where V1 is an Abbe number of the first lens, V6 is an Abbe number of the sixth lens, and V7 is an Abbe number of the seventh lens.

11. An optical imaging system, comprising:
a first lens, a second lens, a third lens, a fourth lens, a fifth lens, a sixth lens, a seventh lens, and an eighth lens disposed in order with a predetermined distance therebetween from an object side,
wherein an Abbe number of each of the second lens and the fourth lens is less than 20, and
wherein 150°<FOV×IMH/f<180° is satisfied,
where FOV is a field of view of the optical imaging system, and f is a total focal length of the optical imaging system.

12. The optical imaging system of claim 11, further comprising:
a stop disposed between the third lens and the fourth lens.

13. The optical imaging system of claim 11, wherein each of three lenses among the first to eighth lenses has a refractive index of 1.6 or greater.

14. The optical imaging system of claim 11, wherein −3<f2/f<−1 and −20<f5/f<−5 are satisfied,
where f2 is a focal length of the second lens, and f5 is a focal length of the fifth lens.

15. The optical imaging system of claim 11, wherein 1<f6/f<6 and −1<f8/f<0 are satisfied,
where f6 is a focal length of the sixth lens, and f8 is a focal length of the eighth lens.

16. The optical imaging system of claim 11, wherein 30<V1-V4<45 is satisfied,
where V1 is an Abbe number of the first lens, and V4 is an Abbe number of the fourth lens.
